(19) United States
(12) Patent Application Publication
(10) Pub. No.: US 2020/0204992 A1
(43) Pub. Date: Jun. 25, 2020

(54) INFORMATION PROCESSING APPARATUS, COMMUNICATION DEVICE, SERVER APPARATUS, AND INFORMATION PROCESSING METHOD

(71) Applicant: FeliCa Networks, Inc., Tokyo (JP)

(72) Inventor: Ryo SAWAKI, Saitama (JP)

(73) Assignee: FeliCa Networks, Inc., Tokyo (JP)

(21) Appl. No.: 16/620,338

(22) PCT Filed: Jul. 5, 2018
(86) PCT No.: PCT/JP2018/025466

§ 371 Date: Dec. 6, 2019

(30) Foreign Application Priority Data
Aug. 22, 2017 (JP) 2017-159107

(51) Int. Cl. H04W 12/06; H04W 4/80; G06F 21/62; G06F 21/73; G06K 19/077

(52) U.S. Cl. CPC H04W 12/06; H04W 4/80; G06F 2221/2141; G06F 21/73; G06K 19/0776; G06F 21/6218

(57) ABSTRACT

There is provided an information processing apparatus, a communication device, a server apparatus, and information processing methods that are capable of communication that makes it difficult to permit access using a copy. The information processing apparatus includes a communication section, a short range wireless communication section, and a control section. The communication section communicates with a server apparatus including a data storage section. The short range wireless communication section establishes short range wireless communication with a communication device including an identifier for specifying an area in the data storage section or an identifier for indicating access authority over access to the data storage section and a communication device identifier for identifying its own communication device. The control section causes the short range wireless communication section to acquire the applicable identifiers and causes the communication section to transmit the applicable identifiers to the server apparatus, and requests permission to access the data storage section.

### TECHNICAL FIELD

The present technology relates to an information processing apparatus, a communication device, a server apparatus, and information processing methods that use short range wireless communication.

### BACKGROUND ART

In recent years, information processing terminals capable of contactless communication with readers/writers (or information processing apparatuses having reader/writer functions) such as contactless integrated circuit (IC) cards or mobile phones equipped with contactless IC chips have been widespread.

In addition, in recent years, information processing terminals such as mobile phones have a function of reading two-dimensional codes such as QR codes (registered trademark) or Data Matrix (registered trademark) codes, for example. Such an information processing terminal is capable of acquiring information such as URL data recorded on, for example, a two-dimensional code, and this makes it possible to save a user of the information processing device the labor to input an URL or the like (see Patent Literature 1 and Patent Literature 2).

### CITATION LIST

### Patent Literature

Patent Literature 1: WO2005/062186 A1

Patent Literature 1: JP 2013-186804 A

### DISCLOSURE OF INVENTION

### Technical Problem

For example, the QR code represents data by arranging light-colored cells and dark-colored cells two-dimensionally. Therefore, it is easy to copy the QR code and it is possible to access the copy of the QR code in addition to directly accessing the original QR code.

In view of the circumstance as described above, it is an object of the present technology to provide an information processing apparatus, a communication device, a server apparatus, and information processing methods that are capable of communication that makes it difficult to permit access using a copy.

### Solution to Problem

In order to achieve the object described above, an information processing apparatus according to the present technology includes a communication section, a short range wireless communication section, and a control section.

The communication section communicates with a server apparatus including a data storage section.

The short range wireless communication section establishes short range wireless communication with a communication device including an identifier for specifying an area in the data storage section or an identifier for indicating access authority over access to the data storage section and a communication device identifier for identifying its own communication device.

The control section causes the short range wireless communication section to acquire the area specification identifier or the identifier for indicating the access authority and the communication device identifier, causes the communication section to transmit the area specification identifier or the identifier for indicating the access authority and the communication device identification identifier to the server apparatus, and requests permission to access the data storage section.

Such a configuration makes it difficult to make a copy because the communication device is configured to establish the short range wireless communication. In addition, the information processing apparatus is configured in a manner that the information processing apparatus cannot access the data storage section unless the information processing apparatus establishes the short range wireless communication with the communication device. Therefore, it is impossible to access the data storage section unless a user of the information processing apparatus holds the communication device. This makes it possible to physically limit the access from the information processing apparatus to the data storage section. Therefore, it is possible to reduce risk of leaking data information stored in the data storage section.

The control section may cause the communication section to acquire an identifier for identifying the information processing apparatus or a user of the information processing apparatus, the identifier being assigned by the server apparatus, may cause the short range wireless communication section to transmit the area specification identifier or the identifier for indicating the access authority, the communication device identifier, and the identifier for identifying the information processing apparatus or the user to the server apparatus, and may request permission to access the data storage section.

As described above, access permission is requested by using the identifier for identifying the information processing apparatus or the identifier for identifying the user. This makes it possible to control access limitation for each information processing apparatus or for each user.

The access authority may include permission of access to the data storage section from only a first information processing apparatus that has accessed the data storage section for a first time by using the communication device, and permission of access to the data storage section from the first information processing apparatus and a second information processing apparatus that is different from the first information processing apparatus and that has accessed the data storage section for a second or subsequent time by using the communication device.

This makes it possible to discriminate whether the data storage section is accessible for only a user of the first information processing apparatus by using the communication device or for everyone including the user of the first information processing apparatus by using the communication device.

The access authority may include permission of access to the data storage section from only a first user of the information processing apparatus who has accessed the data storage section for a first time by using the communication device, and permission of access to the data storage section from the first user and a second user who is different from the first user and who has accessed the data storage section for a second or subsequent time by using the communication device.

This makes it possible to discriminate whether the data storage section is accessible for only the first user by using the communication device or for everyone including the first user and the second user by using the communication device.

An area in the data storage section accessible for the information processing device may be specified on the basis of the area specification identifier or the identifier for indicting the access authority and the communication device identifier.

Accordingly, communication device identifiers are identifiers for identifying different communication devices, and the identifiers are assigned to the respective communication devices. Therefore, one area is prepared for one communication device on the basis of the area specification identifier or the identifier for indicating the access authority and the communication device identifier, and the communication device is associated with data stored in the target area.

The information processing apparatus may further include a data memory section that stores data. The control section may cause the communication section to transmit, to the server apparatus, a request to create a data storage space whose disclosure level is set to an inside of the area, and may control storing of the data in the data storage space created by the server apparatus on the basis of the request.

As described above, the information processing apparatus is capable of creating a data storage space for storing data in an area.

The control section may cause the communication section to transmit disclosure level information set for the data storage space to the server apparatus.

As described above, it is possible for the user of the information processing apparatus to arbitrarily set the disclosure level of the data storage space in accordance with content of stored data.

The information processing apparatus may further include a display section. The control section may control display of data stored in the data storage space on the display section.

The short range wireless communication may be NFC communication.

A communication device according to the present technology includes a communication antenna and an IC chip.

The communication antenna establishes short range wireless communication with an information processing apparatus.

An IC chip includes an identifier for specifying an area in a data storage section of a server apparatus, which is used for specifying an area in the data storage section accessible for the information processing apparatus, or an identifier for indicating access authority over access to the data storage section and a communication device identifier for identifying its own communication device.

Such a configuration makes it possible for the information processing apparatus to use the communication device and access an area specified on the basis of the area specification identifier or the identifier for indicating the access authority and the communication device identifier.

The communication device may further include a label sticker that has an adhesive layer on one surface. The communication antenna and the IC chip may be buried in the label sticker.

As described above, the communication device is configured to include the adhesive layer. This makes it possible to attach the communication device to an outside.

Another surface of the label sticker may have an illustration corresponding to the identifier for indicating the access authority over access to the data storage section.

As described above, the illustration corresponds to the identifier for indicating the access authority. This makes it possible for the user to understand a type of the access authority with reference to the illustration.

Another surface of the label sticker may have an illustration related to content of data stored in the data storage section.

As described above, the illustration is related to the contents of the data. This makes it possible for the user to see the illustration and intuitively understand the contents of the data stored in the data storage section accessible for the user by using the communication device.

A server apparatus according to an aspect of the present technology includes a data storage section, a reception section, and a control section.

The data storage section stores data.

The reception section receives an area specification identifier or an identifier for indicating access authority and a communication device identifier, via an information processing apparatus that establishes short range wireless communication with a communication device including the identifier for specifying an area in a data storage section or the identifier for indicating the access authority over access to the data storage section and the communication device identifier for identifying its own communication device.

The control section receives a request for permission to access the data storage section from the information processing apparatus, and controls access from the information processing apparatus to the data storage section on the basis of the area specification identifier or the identifier for indicating the access authority and the communication device identifier.

Such a configuration makes it possible to physically limit the access from the information processing apparatus to the data storage section. Therefore, it is possible to reduce risk of leaking data information stored in the data storage section.

The server apparatus may further include an identifier generation section that generates an identifier for identifying the information processing apparatus or a user of the information processing apparatus to be assigned to the information processing apparatus or the user, in response to a request from the information processing apparatus.

The reception section may receive the information processing apparatus identifier from the information processing apparatus to which the identifier for identifying the information processing apparatus is assigned, or the user identifier input by the user to whom the identifier for identifying the user is assigned.

The control section may control access from the information processing apparatus to the data storage section on the basis of the area specification identifier or the identifier for indicating the access authority, the communication device identifier, and the information processing apparatus identifier or the user identifier.

As described above, it is possible to control the access by using the information processing apparatus identifier or the user identifier. This makes it possible to control access limitation for each information processing apparatus.

An area in the data storage section accessible for the information processing apparatus may be specified on the basis of the area specification identifier or the identifier for indicating the access authority and the communication device identifier.

As described above, the area is specified on the basis of the area specification identifier or the identifier for indicating the access authority and the communication device identifier. This makes it possible to associate the communication device with data stored in the target area.

The server apparatus may further include a confirmation section that confirms whether the information processing apparatus that has requested access to the data storage section is a first information processing apparatus that has accessed the data storage section for a first time by using the communication device, or a second information processing apparatus that is other than the first information processing apparatus and that has accessed the data storage section for a second or subsequent time by using the communication device.

As described above, the server apparatus confirms whether the information processing apparatus that has requested access to the data storage section is the first information processing apparatus or the second information processing apparatus. This makes it possible to determine whether or not the data storage section is accessible for the information processing apparatus that has requested the access.

The server apparatus may further include a confirmation section that confirms whether a user of the information processing device who has requested access to the data storage section is a first user of the information processing device who has accessed the data storage section for a first time by using the communication device, or a second user who is different from the first user and who has accessed the data storage section for a second or subsequent time by using the communication device.

As described above, the server apparatus confirms whether the user of the information processing apparatus that has requested the access to the data storage section is the first user or the second user. This makes it possible to determine whether or not the data storage section is accessible for the information processing apparatus that has requested the access.

An information processing method according to the present technology includes:

acquiring an area specification identifier or an identifier for indicating access authority and a communication device identifier through short range wireless communication from a communication device including the identifier for specifying an area in a data storage section of a server apparatus or the identifier for indicating the access authority over access to the data storage section and the communication device identifier for identifying its own communication device;

transmitting the area specification identifier or the identifier for indicating the access authority and the communication device identifier to the server apparatus; and

requesting access to the data storage section.

Such an information processing method of the information processing apparatus makes it possible to physically limit the access from the information processing apparatus to the data storage section. Therefore, it is possible to reduce risk of leaking data information stored in the data storage section.

An information processing method according to the present technology includes:

acquiring, from an information processing apparatus, an area specification identifier or an identifier for indicating access authority and a communication device identifier that have been acquired by the information processing apparatus through short range wireless communication with a communication device including the identifier for specifying an area in a data storage section of a server apparatus or the identifier for indicating the access authority over access to the data storage section and the communication device identifier for identifying its own communication device; and

determining whether or not to permit the information processing apparatus to access the data storage section on the basis of the area specification identifier or the identifier for indicating the access authority and the communication device identifier.

Such an information processing method of the server apparatus makes it possible to physically limit the access from the information processing apparatus to the data storage section. Therefore, it is possible to reduce risk of leaking data information stored in the data storage section.

### Advantageous Effects of Invention

As described above, according to the present technology, it is possible to provide the information processing apparatus, the communication device, the server apparatus, and the information processing methods that are capable of communication that makes it difficult to permit access using a copy.

Note that, the effects described herein are not necessarily limited and may be any of the effects described in the present disclosure.

### BRIEF DESCRIPTION OF DRAWINGS

FIG. 1 is a block diagram that illustrates a configuration example of an embodiment of an information processing system to which the present technology is applied, and illustrates functional configuration examples of a server apparatus, an information processing apparatus, and an NFC sticker included in the information processing system.

FIG. 2 is a diagram illustrating examples of an illustration of the NFC sticker.

FIG. 3 is a conceptual diagram illustrating the information processing system illustrated in FIG. 1.

FIG. 4 is a sequence diagram for describing initial registration operation and box creation operation that are performed when service is executed by using the information processing system illustrated in FIG. 1.

FIG. 5 illustrates a display example of the information processing apparatus by using the information processing system illustrated in FIG. 1.

FIG. 6 illustrates display examples of the information processing apparatus by using the information processing system illustrated in FIG. 1.

FIG. 7 is a sequence diagram for describing operation performed in a case where the information processing apparatus accesses the data storage section for a second or subsequent time by using the NFC sticker when service is executed by using the information processing system illustrated in FIG. 1.

FIG. 8 illustrates display examples of the information processing apparatus by using the information processing system illustrated in FIG. 1.

FIG. 9 illustrates display examples of the information processing apparatus when service is executed by using the information processing system illustrated in FIG. 1.

FIG. 10 is a diagram illustrating a configuration example and explanation of an app ID table of the information processing system illustrated in FIG. 1.

FIG. 11 illustrates display examples of the information processing apparatus by using the information processing system illustrated in FIG. 1.

FIG. 12 illustrates display examples of the information processing apparatus by using the information processing system illustrated in FIG. 1.

FIG. 13 illustrates a display example of the information processing apparatus by using the information processing system illustrated in FIG. 1.

FIG. 14 is an example of a UI design displayed on the information processing apparatus.

FIG. 15 is an example of the UI design displayed on the information processing apparatus.

FIG. 16 is an example of the UI design displayed on the information processing apparatus.

FIG. 17 is an example of the UI design displayed on the information processing apparatus of the information processing system.

FIG. 18 is a diagram for describing an application example using the information processing system illustrated in FIG. 1.

FIG. 19 is a diagram for describing an application example using the information processing system illustrated in FIG. 1.

FIG. 20 is a diagram for describing an application example using the information processing system illustrated in FIG. 1.

FIG. 21 is a diagram for describing an application example using the information processing system illustrated in FIG. 1.

### MODE(S) FOR CARRYING OUT THE INVENTION

Hereinafter, an embodiment of the present technology will be described with reference to the drawings.

### <Configuration of Information Processing System>

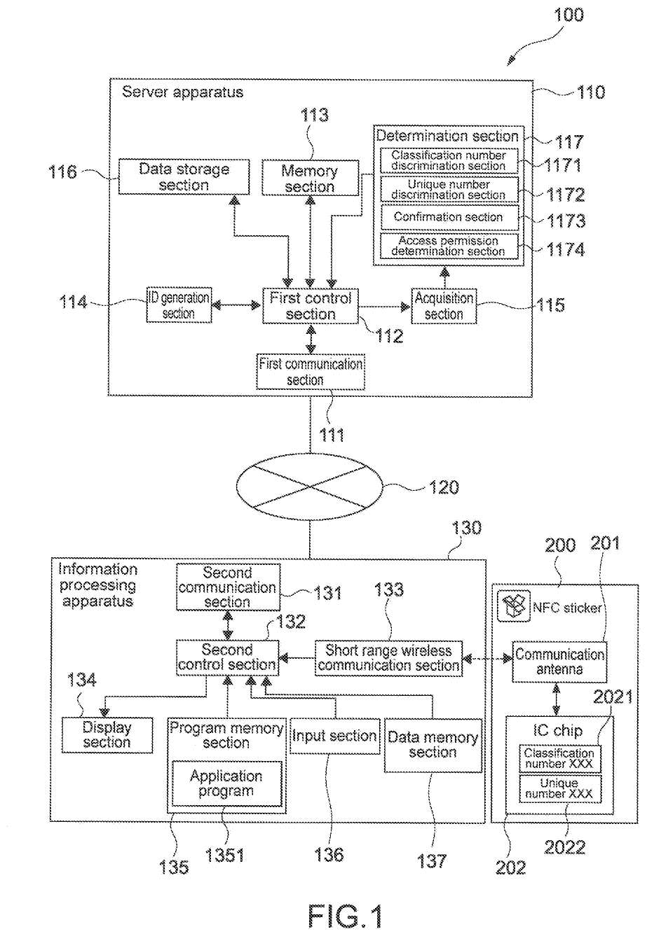

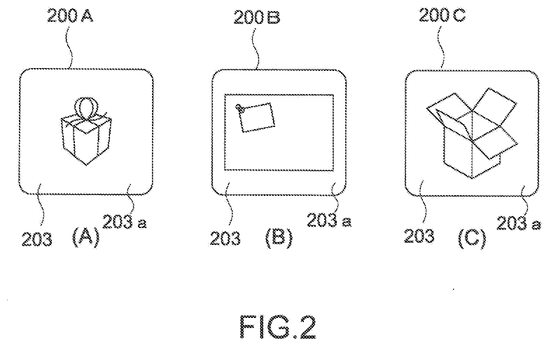

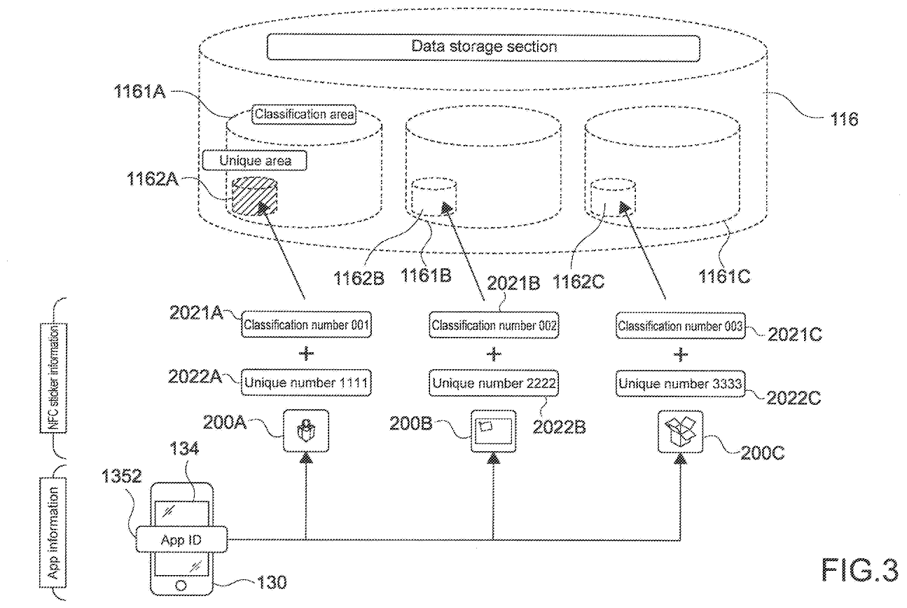

FIG. 1 is a block diagram that illustrates a configuration example of an information processing system according to the present embodiment, and illustrates respective functional configuration examples of a server apparatus, an information processing apparatus, and a near field radio communication (NFC) sticker included in the information processing system. The NFC sticker serves as a communication device. FIG. 2 illustrates examples of appearance of the NFC sticker that serves as the communication device constituting a part of the information processing system illustrated in FIG. 1. FIG. 3 is a conceptual diagram of the information processing system illustrated in FIG. 1.

As illustrated in FIG. 1, an information processing system 100 includes a server apparatus 110, an information processing apparatus 130, an NFC sticker 200, and a communication network 120. The NFC sticker 200 serves as a communication device.

The information processing system 100 is configured in a manner that short range wireless communication is established between the information processing apparatus 130 and the NFC sticker 200 by using an electromagnetic wave, and this makes it possible for the information processing apparatus 130 to access a predetermined storage area in a data storage section 116 of the server apparatus 110.

In the present embodiment, Near-field communication (NFC) is used as the short range wireless communication, and an electromagnetic wave of a frequency (13.56 MHz) conforming to a communication standard of NFC is used for transmission and reception. Note that, it is also possible to establish short range wireless communication in accordance with another communication standard that is different from NFC.

A user of the information processing apparatus 130 is capable of performing operation of storing a file in the predetermined storage area in the data storage section 116, referring to the file stored in the predetermined storage area, and deleting the file, by using the information processing apparatus 130.

The storage area in the data storage section 116 of the server apparatus 110 accessible for the information processing apparatus 130 is specified on the basis of a unique number and a classification number. The unique number is assigned to the NFC sticker 200 that establishes the short range wireless communication with the information processing apparatus 130, and the unique number serves as a communication device identifier for identifying itself. The classification number serves as an identifier for specifying an area in the data storage section, and also serves as an identifier for indicating authority for accessing the data storage section.

[Configuration of Information Processing Apparatus]

The information processing apparatus 130 is a terminal capable of connection to the communication network 120. The information processing apparatus 130 may be, for example, a mobile phone such as a smartphone, a tablet terminal, or the like. Typically, the information processing apparatus 130 is the smartphone. In the present embodiment, a smartphone operable through a touchscreen is taken as an example.

As illustrated in FIG. 1, the information processing apparatus 130 includes a second communication section 131, a second control section 132, a short range wireless communication section 133, a display section 134, a program memory section 135, an input section 136, and a data memory section 137.

The second communication section 131 communicates with another device such as the server apparatus 110 via a wireless network, for example.

The display section 134 displays information received by the second communication section 131, information corresponding to operation performed by the user on the input section 136, or the like. The display section 134 is implemented as an image display panel such as a liquid crystal display or an organic EL display, for example. In addition, it is possible to install a touchscreen in the display section 134.

The input section 136 includes a key, a button, a touchscreen, a microphone, or the like. The data memory section 137 stores various kinds of data such as a document file, a sound file, or an image file created by the user of the information processing apparatus 130. The image file includes a photograph, a video, or the like.

The short range wireless communication section 133 establishes the short range wireless communication with the NFC sticker 200. The short range wireless communication section 133 receives information regarding the NFC sticker 200 by executing the short range wireless communication.

The short range wireless communication section 133 includes a reader/writer, for example. The short range wireless communication can be established between the information processing apparatus 130 and the NFC sticker 200 by generating a predetermined electromagnetic wave and developing electromotive force on the NFC sticker 200. The short range wireless communication section 133 transmits the received information regarding the NFC sticker 200 to the second control section 132.

The program memory section 135 stores an application program 1351 for executing storage service using communication between the information processing apparatus 130 and the server apparatus 110 and communication between the information processing apparatus 130 and the NFC sticker 200.

The second control section 132 controls operation of the information processing apparatus 130. For example, the second control section 132 controls the operation of the information processing apparatus 130 by executing the application program 1351 stored in the program memory section 135.

The control over the operation of the information processing apparatus 130 performed by the second control section 132 after executing the application program 1351 includes: acquisition of an application IDentification (ID) serving as an identifier for identifying the information processing apparatus 130, the application ID being assigned when accessing the server apparatus 110; acquisition of the information regarding the NFC sticker 200 by using the short range wireless communication section 133; transmission of the information regarding the NFC sticker 200 and the application ID of the information processing apparatus 130 to the server apparatus 110; a request to access to the data storage section 116; a request to create a box as a data storage space in a storage area in the data storage section 116; transmission of box information; reading of (reference to) data stored in the data storage section 116; deletion of data, writing (storing) of data on the data storage section 116; display of data stored in the box on the display section 134; and the like.

Data is stored in the data storage section 116 when the user selects a desired piece of data stored in the data memory section 137 of the information processing apparatus 130, for example, and stores the selected piece of data in the data storage section 116.

[Configuration of Communication Network]

The communication network 120 is a wired or wireless communication channel through which information is transmitted from an apparatus connected to the communication network 120 such as the information processing apparatus 130 or the server apparatus 110. For example, the communication network 120 may include a public network such as the Internet, a telephone network, or a satellite communication network, and the like.

[Configuration of Server Apparatus]

As illustrated in FIG. 1, the server apparatus 110 includes a first communication section 111, a first control section 112, a memory section 113, an ID generation section 114, an acquisition section 115, a data storage section 116, and a determination section 117.

The first control section 112 controls operation of the server apparatus 110. For example, the control over the operation of the server apparatus 110 performed by the first control section 112 includes: transmission/reception of information to/from the information processing apparatus 130; generation and assignment of an application ID 1352 in response to an initial registration request from the information processing apparatus 130; acquisition of the application ID 1352, a classification number 2021, and a unique number 2002 from the information processing apparatus 130; control over access from the information processing apparatus 130 to the data storage section 116; control over creation of a box in the data storage section 116; control over reference to data in the box; control over storing of data in the box; control over deletion of data from the box; control over access to the box; and the like.

Here, the box means a container for storing data, which is the data storage space. It is possible to create a plurality of boxes in a target storage area in the data storage section 116.

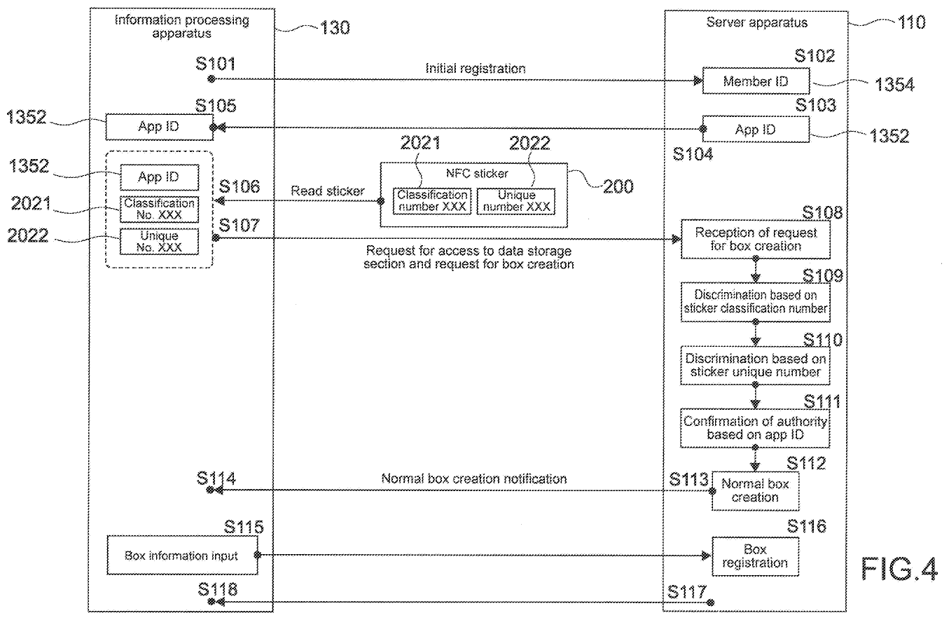

The ID generation section 114 serving as the identifier generation section generates a member ID (a sign 1354 in FIG. 4) and an application ID (a sign 1352 in FIG. 3) in response to a request from the information processing apparatus 130.

The member ID is for specifying the user specific to the information processing apparatus 130 on the basis of a solid recognition number of the information processing apparatus 130 or personal information regarding the user.

The application ID 1352 is identifier that is assigned to each application. The application ID 1352 makes it possible to identify whether or not it is a valid application user. In addition, in the present embodiment, different application IDs are assigned to respective information processing apparatuses on the basis of solid recognition numbers of the information processing apparatuses 130, and the application IDs also function as identifiers for identifying the different information processing apparatuses.

The solid recognition numbers of the information processing apparatuses 130, pieces of personal information regarding users, member IDs, and the application IDs 1352 are associated with each other, and stored in the memory section 113 through an initial registration process. Note that, in the drawings, the application IDs 1352 are abbreviated to app IDs.

The acquisition section 115 acquires the application ID 1352 of the information processing apparatus 130, the classification number 2021 of the NFC sticker 200, the unique number 2022 of the NFC sticker 200, and the like.

In the present embodiment, the classification number 2021 is an identifier for indicating authority of the information processing apparatus 130 over access to the data storage section 116, and is also an identifier for specifying an area (storage area) in the data storage section 116.

Note that, here, the numbers are used as the identifier for indicating the access authority and the identifier for specifying the area. However, it is also possible to use signs (IDs). In addition, in the present embodiment, the identifier that serves as the identifier for indicating the access authority and also serves as an area specification identifier is taken as an example. However, the present technology is not limited thereto. In other words, the identifier may be the identifier for indicating the access authority only, or may be the identifier for specifying the area only.

The unique number 2022 is a communication device identification number for identifying the NFC sticker 200 that serves as the communication device. Therefore, different NFC stickers 200 have different unique numbers. Note that, here, the number is used as the communication device identifier for identifying the communication device itself. However, it is also possible to use a sign (ID).

The classification number 2021 and the unique number 2022 are numbers that are preliminarily assigned to each NFC sticker 200. Details thereof will be described later.

The memory section 113 stores the solid recognition number of the information processing apparatus, the personal information regarding the user, the member ID, and the application ID 1352 in association with each other at a time of the initial registration process.

In addition, the memory section 113 stores the application ID 1352, the classification number 2021 and the unique number 2022 of the NFC sticker 200, information indicating whether the user of the information processing apparatus 130 to which the application ID 1352 is assigned is an administrator or a non-administrator user of the NFC sticker 200 in association with each other for permitting access from the information processing apparatuses 130 to the data storage section 116.

The first communication section 111 communicates with the information processing apparatus 130 via the communication network 120. The first communication section 111 also functions as a reception section that receives the classification number 2021 that is the area specification identifier and the identifier for indicating the access authority, and the unique number 2022 that is the communication device identifier, via the information processing apparatus 130 that establishes the short range wireless communication with the NFC sticker 200.

The determination section 117 determines whether to permit or prohibit the access from the information processing apparatus 130 to the data storage section 116 on the basis of the application ID 1352, the classification number 2021, and the unique number 2022 that have been acquired by the acquisition section 115.

The determination section 117 includes a classification number discrimination section 1171, a unique number discrimination section 1172, a confirmation section 1173, and an access permission determination section 1174.

The classification number discrimination section 1171 discriminates the type of the authority over the access from the information processing apparatus 130 using the NFC sticker 200 to the data storage section 116, on the basis of the classification number 2021 acquired by the acquisition section 115.

The unique number discrimination section 1172 discriminates the unique number 2022 acquired by the acquisition section 115. It is possible to specify a storage area in the data storage section 116 accessible for the information processing apparatus 130, on the basis of the classification number 2021 and the unique number 2022.

The confirmation section 1173 confirms whether the user is the administrator or the non-administrator user, on the basis of the classification number 2021, the unique number 2022, and the application ID that has been assigned to the information processing apparatus 130 by the server apparatus 110.

As described above, it is possible to confirm whether the user is the administrator or the non-administrator user by using the application ID serving as the information processing apparatus identifier. This makes it possible to control access limitation for each information processing apparatus.

Here, the administrator is typically a user who operates the first information processing apparatus that has accessed the data storage section 116 for a first time by using the NFC sticker 200. The non-administrator user is a user who operates the second information processing apparatus that is different from the first information processing apparatus and that has accessed the data storage section 116 for a second or subsequent time by using the NFC sticker 200 that has already been used by the administrator.

In the present embodiment, one user is registered with regard to one information processing apparatus. Therefore, the step of causing the confirmation section 1173 to confirm whether the user is the administrator or the non-administrator user can be referred to as a step of confirming whether the information processing apparatus is the first information processing apparatus or the second information processing apparatus.

The access permission determination section 1174 determines whether to permit or prohibit access to the data storage section 116 from the information processing apparatus 130 that has requested the access to the data storage section 116, on the basis of the discrimination result obtained by the classification number discrimination section 1171, the discrimination result obtained by the unique number discrimination section 1172, and the confirmation result obtained by the confirmation section 1173.

Details of operation of the determination section 117 will be described.

First, when the information processing apparatus 130 requests permission to access the data storage section 116 by using the NFC sticker 200, the acquisition section 115 acquires the application ID 1352, the classification number 2021, and the unique number 2022 from the information processing apparatus 130.

The classification number discrimination section 1171 discriminates whether or not the acquired classification number 2021 is identical to a classification number stored in the memory section 113.

When the classification number discrimination section 1171 discriminates the acquired classification number 2021 as a classification number that is not stored, the confirmation section 1173 determines that this is first-time access using the target NFC sticker 200, and confirms the user of the information processing apparatus 130 that has accessed the data storage section 116 is an administrator of the target NFC sticker 200.

The access permission determination section 1174 considers that the information processing apparatus 130 has accessed the data storage section 116 for the first time by using the NFC sticker 200, and permits the access from the information processing apparatus 130 to the data storage section 116.

The first control section 112 causes the memory section 113 to store the acquired classification number 2021, unique number 2022, and application ID 1352 in association with information indicating that the user is the administrator of the NFC sticker 200.

On the other hand, when the classification number discrimination section 1171 discriminates the classification number 2021 as a classification number identical to a stored classification number and the classification number 2021 is discriminated as a classification number indicating access authority that permits only the administrator to access the data storage section 116, the unique number discrimination section 1172 discriminates whether or not the acquired unique number 2022 is identical to the unique number associated with the classification number stored in the memory section 113.

When the unique number discrimination section 1172 discriminates the unique number 2022 as the unique number identical to the stored unique number, the confirmation section 1173 discriminates whether or not the acquired application ID 1352 is identical to the application ID associated with the classification number and the unique number that are stored in the memory section 113. This makes it possible to confirm whether the user is the administrator or the non-administrator user.

When the application ID 1352 is discriminated as the application ID identical to the stored application ID, the confirmation section 1173 confirms that the user of the information processing apparatus 130 that has accessed the data storage section 116 is the administrator because the classification number discrimination section 1171 has already discriminated the classification number 2021 as the classification number indicating the access authority that permits only the administrator to access the data storage section 116. Subsequently, the access permission determination section 1174 permits the access to the data storage section 116 from the information processing apparatus 130 that has accessed the data storage section 116.

On the other hand, when the application ID 1352 is discriminated as an application ID that is not identical to the stored application ID, the confirmation section 1173 confirms that the user of the information processing apparatus 130 that has accessed the data storage section 116 is the non-administrator user of the NFC sticker 200.

The access permission determination section 1174 does not permit but prohibits the access to the data storage section 116 from the information processing apparatus 130 that has requested the access. This is because the classification number discrimination section 1171 discriminates the access authority as the access authority that permits only the administrator to access the data storage section 116, and the confirmation section 1173 discriminates the user as the non-administrator user.

Next, a case where the classification number discrimination section 1171 discriminates the classification number 2021 as a stored classification number and the classification number 2021 is discriminated as the classification number indicating access authority that permits the authority and the non-administrator user to access the data storage section 116, will be described.

The unique number discrimination section 1172 discriminates whether or not the acquired unique number 2022 is identical to a unique number associated with the classification number stored in the memory section 113.

When the unique number discrimination section 1172 discriminates the unique number 2022 as the unique number identical to the stored unique number, the confirmation section 1173 discriminates whether or not the acquired application ID 1352 is identical to the application ID associated with the classification number and the unique number that are stored in the memory section 113, and confirms whether the user is the administrator or the non-administrator user.

When the application ID 1352 is discriminated as the application ID identical to the stored application ID, the confirmation section 1173 confirms whether the user of the information processing apparatus 130 that has accessed the data storage section 116 is the administrator or the non-administrator user, on the basis of the information associated with classification number, unique number, and application ID stored in the memory section 113, the information indicating the administrator or the non-administrator user.

As described above, in the case where the acquired classification number, unique number, and application ID are respectively identical to the classification number, unique number, and application ID stored in the memory section 113 in association with each other, this means that the information processing apparatus 130 that has requested the access has experienced the access in the past by using the same NFC sticker 200.

The access permission determination section 1174 permits the access from the information processing apparatus 130 to the data storage section 116 because the classification number indicates the access authority that permits the administrator and the non-administrator user to access the data storage section 116.

On the other hand, when the application ID 1352 is discriminated as an application ID that is not identical to the stored application ID, it is determined that that the target NFC sticker 200 has already belonged to an administrator, because the classification number and the unique number have already been stored in the memory section 113 in association with each other. Therefore, the confirmation section 1173 confirms that the user of the information processing apparatus 130 that has accessed the data storage section 116 is the non-administrator user of the NFC sticker 200.

The access permission determination section 1174 permits the access from the information processing apparatus 130 to the data storage section 116 because the classification number indicates the access authority that permits the administrator and the non-administrator user to access the data storage section 116.

The first control section 112 causes the memory section 113 to store the classification number 2021, the unique number 2022, the application ID 1352, and information indicating that the user is the non-administrator user of the NFC sticker 200 in association with each other.

As described above, the first control section 112 controls the access from the information processing apparatus 130 to the data storage section 116 on the basis of the access permission/prohibition determination result obtained by the determination section 117 with reference to the classification number 2021, the unique number 2022, the application ID 1352.

As described above, the determination section 117 determines whether to permit or prohibit the access to the data storage section 116 from the information processing apparatus 130 that has requested the access, on the basis of the acquired classification number, unique number, and application ID while referring to the information stored in the memory section 113 that stores the classification number, the unique number, the application ID, and information indicating the administrator or the non-administrator user in association with each other.

The data storage section 116 stores data selected by the user of the information processing apparatus 130.

The information processing apparatus 130 accesses the data storage section 116 by executing the application program 1351. This makes it possible for the user of the information processing apparatus 130 to store, in the data storage section 116, data that is selected by the user and stored in the data storage section 137 in the information processing apparatus 130.

In addition, it is also possible for the user to refer to and delete the data stored in the data storage section 116 by using the information processing apparatus 130.

[Configuration of NFC Sticker]

The NFC sticker 200 is a communication device capable of the short range wireless communication. The NFC sticker 200 includes a communication antenna 201, an IC chip 202, and a label sticker 203. The communication antenna 201 and the IC chip 202 are buried in the label sticker 203.

The label sticker 203 has a thin sheet-like shape. The label sticker 203 has an adhesive layer on its one surface, and has an illustration on another surface 203a. To the IC chip 202, the unique number 2022 and the classification number 2021 are assigned in advance for specifying the NFC sticker itself equipped with the IC chip 202.

When the information processing apparatus 130 comes close to the NFC sticker 200, the communication antenna 201 of the NFC sticker 200 reacts with an electromagnetic wave emitted by the information processing apparatus 130, and electromotive force is developed. Subsequently, the IC chip 202 operates by using the electromotive force as power supply.

This makes it possible to transmit information regarding the NFC sticker 200 to the information processing apparatus 130 via the communication antenna 201 and the short range wireless communication section 133 of the information processing apparatus 130. The information regarding the NFC sticker 200 includes the unique number 2022, the classification number 2021, and the like stored in the IC chip 202.

As illustrated in FIG. 2, the NFC sticker 200 has substantially square sheet-like appearance of 25 mm on a side, for example. FIG. 2 illustrates an example of the respective NFC stickers 200 having different illustrations. In the present embodiment, the types of the illustrations on the other surfaces 203a correspond to respective classification numbers 2021 assigned to the NFC stickers 200.

In the present embodiment, a case where the type of authority over access from the information processing apparatus 130 using the NFC sticker 200 to the data storage section 116 and a storage area to be accessed are specified on the basis of the classification number 2021 and the classification number 2021 also indicates the type of a user interface (UI) design, will be taken as an example.

The access authority includes two types of authority, which are authority that permits access from only the administrator (the user of the first information processing apparatus) and authority that permits access from everyone including the administrator (the user of the first information processing apparatus) and the non-administrator user (the user of the second information processing apparatus).

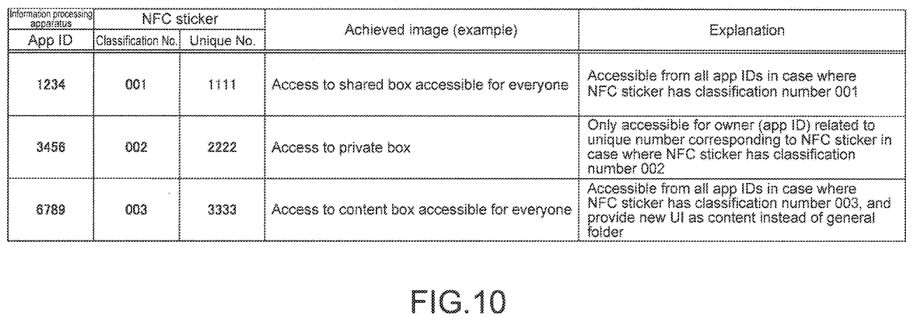

The classification number 2021 will be described. FIG. 10 illustrates a configuration example and explanation of an application ID table stored in the memory section 113 of the server apparatus 110. Next, with reference to FIG. 10, types of the authority over access to the data storage section 116 and types of the UI designs that are associated with respective NFC stickers 200A to 200C will be described.

As regards explanations of three NFC stickers in FIG. 10, the top row corresponds to the NFC sticker 200A illustrated in FIG. 2(A), the middle row corresponds to the NFC sticker 200B in FIG. 2(B), and the bottom row corresponds to the NFC sticker 200C illustrated in FIG. 2(C). Here, the classification numbers 2021 correspond to the respective illustrations on the NFC stickers 200. In other words, the respective illustrations correspond to the types of the access authority and the types of the UI designs.

In FIG. 10, a case where the three different information processing apparatuses respectively use the different NFC stickers 200A to 200C to access the data storage section 116 of the server apparatus 110.

To the NFC sticker 200A illustrated in FIG. 2(A), a classification number 001 and a unique number 1111 are assigned. To the NFC sticker 200B illustrated in FIG. 2(B), a classification number 002 and a unique number 2222 are assigned. To the NFC sticker 200C illustrated in FIG. 2(C), a classification number 003 and a unique number 3333 are assigned.

Note that, in the case where there is no need to discriminate particularly between the NFC stickers 200A to 200C, these NFC stickers 200A to 200C are simply referred to as the NFC stickers 200 for description. In a similar way, in the case where there is no need to discriminate particularly between classification numbers 2021A to 2021C and unique numbers 2022A to 2022C of the respective NFC stickers 200A to 200C, they are simply referred to as the classification numbers 2021 and the unique numbers 2022.

In response to access from the three different information processing apparatuses 130 using the different NFC stickers 200A to 200C, the memory section 113 of the server apparatus 110 stores the application IDs 1352 of the respective information processing apparatuses 130, and the classification numbers 2021 and the unique numbers 2022 that are assigned to the respective NFC stickers 200 in association with each other.

When the information processing apparatus 130 to which the application ID 1352 of the number 1234 is assigned accesses the data storage section 116 by using the NFC sticker 200A, the memory section 113 stores pieces of information indicating the application ID of 1234, the classification number of 001, and the unique number of 1111 in association with each other.

When the information processing apparatus 130 to which the application ID 1352 of the number 3456 is assigned accesses the data storage section 116 by using the NFC sticker 200B, the memory section 113 stores pieces of information indicating the application ID of 3456, the classification number of 002, and the unique number of 2222 in association with each other.

When the information processing apparatus 130 to which the application ID 1352 of the number 6789 is assigned accesses the data storage section 116 by using the NFC sticker 200C, the memory section 113 stores pieces of information indicating the application ID of 6789, the classification number of 003, and the unique number of 3333 in association with each other.

The classification number 001 assigned to the NFC sticker 200A with an illustration of a present illustrated in FIG. 2(A) indicates that the administrator and the non-administrator user are capable of accessing the data storage section 116 by using the NFC sticker 200A and a UI design displayed on the display section 134 of the information processing apparatus 130 is a general one. Details of the UI design will be described later.

Accordingly, both the administrator and the non-administrator user are capable of accessing the data storage section 116 by using the NFC sticker 200A, and are capable of referring to, storing, and deleting data in the data storage section 116.

The classification number 002 assigned to the NFC sticker 200B with an illustration of a bulletin board illustrated in FIG. 2(B) indicates that only the administrator is capable of accessing the data storage section 116 by using the NFC sticker 200B and a UI design displayed on the display section 134 of the information processing apparatus 130 is a general one.

Accordingly, only the administrator is capable of accessing the data storage section 116 by using the NFC sticker 200B, and is capable of referring to, storing, and deleting data in the data storage section 116. On the other hand, it is impossible for the non-administrator user to use the NFC sticker 200B.

The classification number 003 assigned to the NFC sticker 200C with an illustration of a cardboard box illustrated in FIG. 2(C) indicates that the administrator and the non-administrator user are capable of accessing the data storage section 116 by using the NFC sticker 200C and a UI design displayed on the display section 134 of the information processing apparatus 130 is a special design.

Accordingly, both the administrator and the non-administrator user are capable of accessing the data storage section 116 by using the NFC sticker 200C, and are capable of referring to, storing, and deleting data in a predetermined storage area in the data storage section 116.

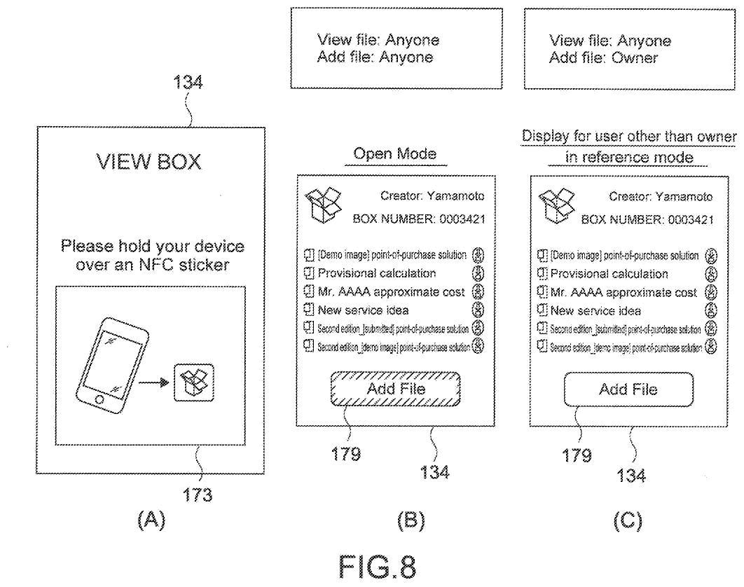

FIG. 8(B) and FIG. 14 to FIG. 17 are examples of an UI design displayed on the display section 134 of the information processing apparatus 130.

In the case of the general UI design, file names are simply listed as illustrated in FIG. 14, FIG. 8(B), and the like, arrangement of the files is not remarkable, and a color and a pattern of a background, and the like are not creatively designed.

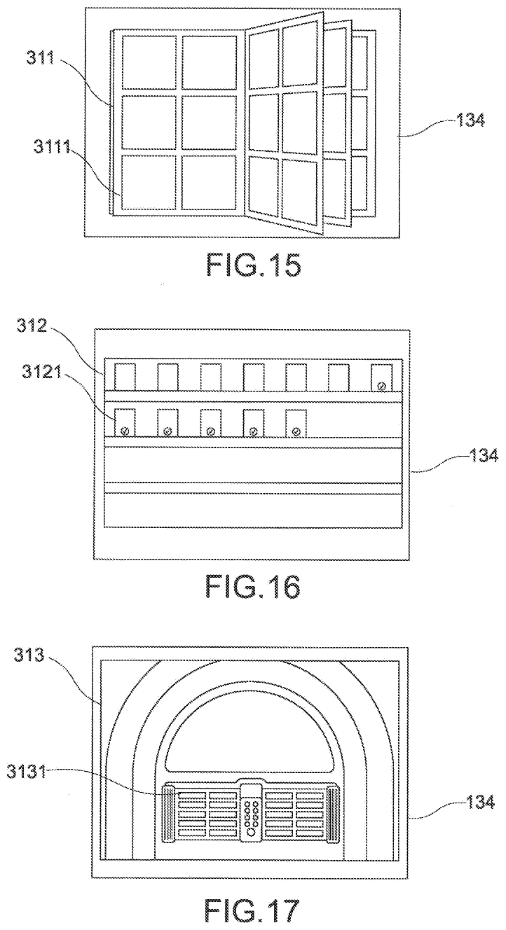

In the case of the special UI design, for example, as illustrated in FIG. 15 to FIG. 17, a color, a pattern, and the like of a background is creatively designed, and arrangement and the like of files are designed in conformity with the background.

For example, FIG. 15 illustrates a UI design of a photo album mode in which data files such as photographs 3111 selected by a user are displayed as if they were put on pieces of heavy paper 311 of an album. The user slides his/her finger on the display section 134. This makes it possible for the user to refer to the files as if the user turned a page of the album.

FIG. 16 illustrates an UI design of a bookshelf mode. In the bookshelf mode, the UI is designed in a manner that magazine-like icons 3121 of files are put in a bookshelf 312.

FIG. 17 illustrates an UI design of a jukebox mode. In the jukebox mode, the UI is designed in a manner that music titles indicating music data files are listed on a jukebox 313.

As described above, it is also possible for the user to arbitrarily select a UI design in accordance with contents of files to be recorded on the data storage section 116.

The present embodiment has been configured in a manner that the illustrations respectively correspond to the types of access authority and the types of UI designs. However, the present technology is not limited thereto. For example, the types of access authority may correspond to illustrations, or illustrations of NFC stickers may be related to contents of files stored in the data storage section.

As regards an example of the illustration related to contents of a file stored in the data storage section, the illustration of the NFC sticker 200 may be an illustration of a photo album in the case where the display section 134 displays files by using the UI design of the photo album mode illustrated in FIG. 15. Alternatively, in another example, the illustration of the NFC sticker 200 may be a photograph of a child, and data related to the child is stored. This makes it possible to organize data such as photographs.

Accordingly, it is possible for the user to intuitively understand what kind of contents of data is stored in the data storage section corresponding to the NFC sticker 200 with reference to the illustration put on the NFC sticker 200. This makes it easier to search the stored data, and this is convenient.

The unique number 2022 is a number assigned to the NFC sticker 200 itself. The different numbers are assigned to the respective NFC stickers 200.

In addition, in the present embodiment, the NFC stickers 200 are stickers including adhesive layers. This makes it possible for the user to put the NFC sticker 200 on any external place. Although application examples will be described later, data related to the place on which the NFC sticker 200 is put is stored in a corresponding storage area in the data storage section. This makes it possible for the user to manage information by organizing pieces of the information in association with respective places on which the NFC stickers 200 are put.

In the present embodiment, NFC stickers are used as examples of a sticker-type communication device. However, the communication device may be an NFC card that is a card-type communication device, for example. The form of the communication device is not limited to such a sticker or card.

With reference to FIG. 3, an overview of the information processing system 100 will be described. FIG. 3 is a conceptual diagram illustrating a case where the single information processing apparatus 130 accesses the data storage section 116 by using the plurality of NFC stickers 200A to 200C.

As illustrated in FIG. 3, for example, the classification number 001 (the sign 2021A) and the unique number 1111 (the sign 2022A) are assigned to the NFC sticker 200A, the classification number 002 (the sign 2021B) and the unique number 2222 (the sign 2022B) are assigned to the NFC sticker 200B, and the classification number 003 (the sign 2021C) and the unique number 3333 (the sign 2022C) are assigned to the NFC sticker 200C.

The server apparatus 110 assigns the application ID 1352 to the information processing apparatus 130 through initial registration.

The information processing apparatus 130 establishes the short range wireless communication with the NFC sticker 200A (200B, 200C) and acquires the classification number 2021A (2021B, 2021C) and the unique number 2022A (2022B, 2022C).

The information processing apparatus 130 transmits the application ID 1352, the classification number 2021A (2021B, 2021C) and the unique number 2022A (2022B, 2022C) to the server apparatus. When the server apparatus 110 permits access on the basis of such information, it becomes possible for the information processing apparatus 130 to access the data storage section 116.

The data storage section 116 of the server apparatus 110 has classification areas 1161A to 1161C corresponding to the respective classification numbers assigned to the NFC stickers 200. In addition, the classification area 1161A to 1161C have respective unique areas 1162A to 1162C corresponding to the unique numbers assigned to the NFC stickers 200.

A storage area in the data storage section 116 accessible for the information processing apparatus 130 using the NFC sticker 200A (200B, 200C) is specified on the basis of the classification area 1161A (1161B, 1161C) and the unique area 1162A (or 1162B or 1162C) that are decided on the basis of the classification numbers 2021A (2021B, 2021C) and the unique numbers 2022A (2022B, 2022C).

In the present embodiment, the plurality of unique areas is prepared in the respective classification areas in accordance with the unique numbers. Therefore, the unique area 1162A is a storage area accessible for the NFC sticker 200A. In a similar way, the unique area 1162B is a storage area accessible for the NFC sticker 200B, and the unique area 1162C is a storage area accessible for the NFC sticker 200C.

As described above, by using the classification number 2021 and the unique number 2022 assigned to the NFC sticker 200, it is possible to specify a storage area in the data storage section 116 accessible for the information processing apparatus 130 that has established the short range wireless communication with the NFC sticker 200. In other words, the NFC sticker 200 is associated with data stored in the data storage section 116.

<Description of Operation of Information Processing System>

[Description of Operation performed at time of Initial Registration and Box Creation]

With reference to FIG. 4 to FIG. 6, initial registration operation performed when executing the application program 1351 by using the above-described information processing system 100 will be described.

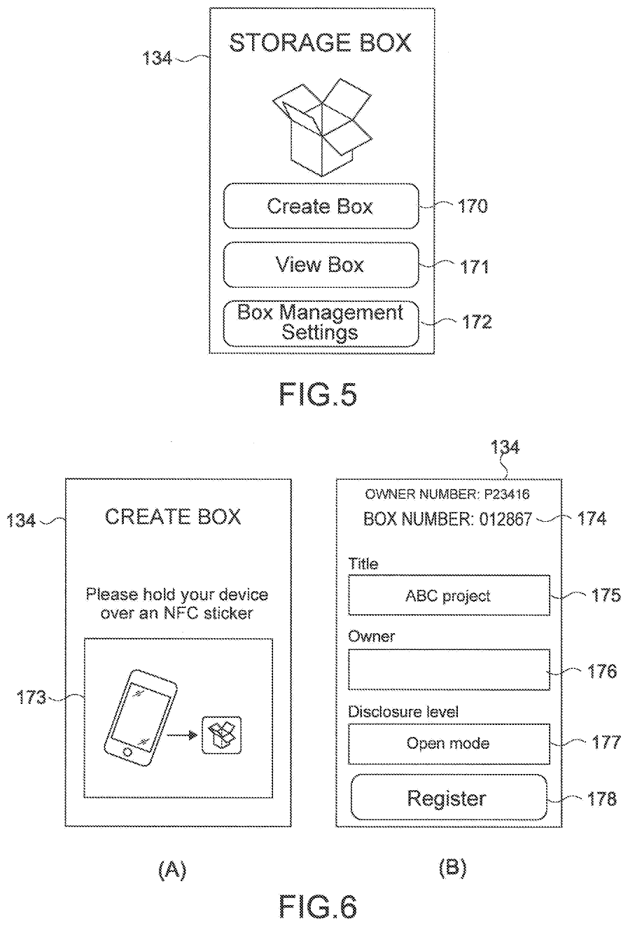

FIG. 4 is a sequence diagram for describing the initial registration operation and the box creation operation. FIG. 5 and FIG. 6 are examples of a screen displayed on the display section 134 of the information processing apparatus 130 when executing the application program. FIG. 5 illustrates a task selection screen. FIG. 6 illustrates a screen displayed when creating a box. Next, the following description will be given with reference to FIG. 4.

First, the user prepares the NFC sticker 200, and installs the application program 1351 into the information processing apparatus 130. Here, a case of using the NFC sticker 200 including a classification number indicating access authority that permits access from the administrator and the non-administrator user will be mainly described.

When the application program 1351 installed by the user is executed, the second control section 132 causes the display section 134 to display an initial registration setting screen (not illustrated).

When the user finishes inputting s items such as personal information and selects execution of the initial registration (Step S101), the second control section 132 causes the second communication section 131 to transmit information regarding the solid recognition number of the information processing apparatus 130, the personal information, a request for the initial registration, and the like to the server apparatus 110 via the communication network 120.

The first communication section 111 of the server apparatus 110 receives the request from the information processing apparatus 130. In response to the request, the first control section 112 causes the ID generation section 114 to generate a member ID 1354 that makes it possible to specify a user specific to the information processing apparatus 130 on the basis of the received solid recognition number and personal information.

In addition, the first control section 112 causes the ID generation section 114 to generate the application ID 1352 on the basis of the received solid recognition number (Step S103). The application ID 1352 serves as the recognition number of the information processing apparatus 130.

The first control section 112 causes the first communication section 111 to transmit the generated application ID 1352 to the information processing apparatus 130 (Step S104). When the information processing apparatus 130 receives the application ID 1352, the application ID 1352 is assigned to the information processing apparatus 130 (Step S105). In such a way, the initial registration of the information processing apparatus 130 is completed.

When the initial registration is completed, it becomes possible to create a box. Next, details of the box creation will be described.

When the initial registration is completed, the second control section 132 causes the display section 134 to display the task selection screen illustrated in FIG. 5. As illustrated in FIG. 5, the display section 134 displays three selection buttons including a “Create Box” button 170, a “View Box” button 171, and a “Box Management Settings” button 172.

When the user taps and selects the “Create Box” button 170, the second control section 132 causes the display section 134 to display an image 173 that instructs to bring the information processing apparatus 130 close to the NFC sticker 200 and connect them through the short range wireless communication, as illustrated in FIG. 6(A).

When the user holds the information processing apparatus 130 over the NFC sticker 200 in accordance with the image 173 and the short range wireless communication is established between the information processing apparatus 130 and the NFC sticker 200, it becomes possible to read information regarding the NFC sticker 200. The second control section 132 causes the short range wireless communication section 133 to receive the classification number 2021 and the unique number 2022 that are the information regarding the NFC sticker 200 (Step S106).

When the reception of the classification number 2021 and the unique number 2022 finishes, the second control section 132 causes the second communication section 131 to transmit the application ID 1352, the classification number 2021, and the unique number 2022 to the server apparatus 110 (Step S107). After the application ID 1352, the classification number 2021, and the unique number 2022 are transmitted, access to the data storage section 116 and box creation are requested.

When the first communication section 111 receives the request for the access to the data storage section 116 and the box creation (Step S108), the first control section 112 causes the acquisition section 115 to acquire the received classification number 2021, unique number 2022, and application ID 1352.

The first control section 112 causes the determination section 117 to determine whether to permit the access to the data storage section 116 on the basis of the application ID 1352, classification number 2021, and unique number 2022 acquired by the acquisition section 115.

Next, details of operation of the determination section 117 will be described. First, the classification number discrimination section 1171 of the determination section 117 discriminates whether or not the acquired classification number 2021 is stored in the memory section 113.

Here, the example of creating a box for the first time is described. Therefore, information for permitting the access to the data storage section 116 is not yet recorded on the memory section 113. Accordingly, the classification number discrimination section 1171 discriminates the acquired classification number 2021 as a classification number that is not stored in the memory section, and additionally discriminates the type of access authority on the basis of the classification number 2021 (Step S109). Here, the access authority is discriminated as authority that permits access from the administrator and the non-administrator user, and the classification number discrimination section 1171 additionally discriminates the classification area 1161 in the data storage section 116.

Next, the unique number discrimination section 1172 of the determination section 117 discriminates the unique number 2022 (Step S110). This makes it possible to discriminate a unique area 1162 in the classification area 1161 and specify a storage area in the data storage section 116 accessible for the information processing apparatus 130. Here, the storage area is the region of the unique area 1162 in the classification area 1161.

Next, the confirmation section 1173 confirms whether the user of the information processing apparatus 130 that has requested the access is the administrator or the non-administrator user on the basis of the application ID 1352 (Step S111). Here, the information processing apparatus 130 has accessed the data storage section 116 for the first time by using the NFC sticker 220 and the memory section 113 has not yet recorded information for permitting the access to the data storage section 116. Therefore, the confirmation section 1173 confirms that the user of the information processing apparatus 130 is the administrator.

Next, the access permission determination section 1174 determines whether to permit or prohibit access from the information processing apparatus 130 to the data storage section 166, on the basis of the discrimination result obtained by the classification number discrimination section 1171, the discrimination result obtained by the unique number discrimination section 1172, and the confirmation result obtained by the confirmation section 1173. Here, the access permission determination section 1174 determines that the access is permitted.

Next, the first control section 112 causes the memory section 113 to store the classification number 2021, the unique number 2022, the application ID 1352, and the information indicating that the user is the administrator of the NFC sticker 200 in association with each other.

When the determination section 117 finishes determining whether to permit the access, the first control section 112 creates a box in a predetermined storage area in the data storage section 116 on the basis of the determination result indicating the permission of the access (Step S112).

To the created box, a number is assigned. When the box is created, the first control section 112 causes the first communication section 111 to transmit box number information and a notification to the information processing apparatus 130 (Step S113). The notification indicates that the access to the data storage section is permitted and the box is normally created.

When the second control section 131 receives the access permission notification and the normal box creation notification (Step S114), the second control section 132 causes the display section 134 to display a box information input screen as illustrated in FIG. 6(B).

The box information input screen displays a box number 174 received from the server apparatus 110, a title input form 175, an owner input form 176, and disclosure level form 177, a registration button 178, or the like.

The box number is a number for identifying a box. In the title input form 175, a name of the box is input. The name of the box is arbitrarily decided by the user.

The owner is the user who has created the target box. The box is created by using the NFC sticker 200 with the access authority that permits the access from the administrator and the non-administrator user. Therefore, it is possible for both the administrator and the non-administrator user to be the owner of the box. In the owner input form 176, any name is input by the user.

The disclosure level form 177 shows the type of the disclosure level of the box. There are three types of disclosure levels, which are an open mode, a reference mode, and an exclusive mode. They indicate the types of limitation of access to the box.

The disclosure level is arbitrarily selected by an owner of the box. For example, the disclosure levels are displayed by using a pull-down list. For example, when the open mode is selected, the wording “Open Mode” is displayed in the disclosure level form 177.

Note that, the access authority indicates the access from the information processing apparatus to the data storage section, and the disclosure level indicates the access from the information processing apparatus to the box. Both the access authority and the disclosure level are respectively used for specifying the information processing apparatus capable of accessing the data storage section and the box.

In the present embodiment, the access authority is set in advance by using the classification number assigned to the NFC sticker, and it is impossible for the user to change the type of the access authority. On the other hand, it is possible for the owner of the box to arbitrarily change the disclosure level.

The disclosure level is set for each box, and only the owner who has created the box can arbitrarily change its disclosure level. A case of changing the settings related to the disclosure level will be described later.

In the case where the box is set to the open mode, everyone including the owner of the box and the other users is capable of referring to, storing, and deleting data in the target box.

In the case where the box is set to the reference mode, only the owner who has created the box is capable of referring to, storing, and deleting data in the target box. Users other than the owner of the box are only capable of referring to the data in the box, but cannot store or delete the data in the box.

In the case where the box is set to the exclusive mode, only the owner who has created the box is capable of referring to, storing, and deleting data in the target box. Users other than the owner of the box cannot refer to, store or delete the data in the target box.

Note that, in the case of using the NFC sticker 200 indicating the authority that only permits access from the administrator, no one can access the data storage section 116 by using the NFC sticker 200 except the administrator.

When the input to the title input form 175 and the owner input form 176 in the input screen illustrated in FIG. 6(B) are finished and the user selects the registration button 178, the second control section 132 causes the second communication section 131 to transmit the input box information to the server apparatus 110 (Step S115). The box information includes box number information, title information, owner name information, and disclosure level information.

When the first communication section 111 receives the box information, the first control section 112 causes the memory section 113 to store the application ID 1352, the classification number 2021, the unique number 2022, the box number, and the box information in association with each other, and registers the box (Step S116).

When the registration of the box finishes, the first control section 112 causes the first communication section 111 to notify the information processing apparatus 130 of completion of the box registration (Step S117), and the second communication section 131 receives the notification of the completion of the box registration (Step S118). This makes it possible for the information processing apparatus 130 to store, refer to, and delete the data in the registered box.

[Description of Operation Performed in Case of Second or Subsequent Access to Data Storage Section by using NFC Sticker]

Next, a case where a user who is the administrator accesses the data storage section by using the NFC sticker 200 for a second or subsequent time and a case where a user who is the non-administrator user accesses the data storage section by using the NFC sticker 200 for a second or subsequent time will be separately described. Here, a case of using the NFC sticker 200 for which the access authority that permits access from the administrator and the non-administrator user is set will be described.

Here, for descriptive purposes, an information processing apparatus used by the administrator of the NFC sticker 200 is referred to as a first information processing apparatus 130A, and an information processing apparatus used by the non-administrator user of the NFC sticker 200 is referred to as a second information processing apparatus 130B. The first information processing apparatus 130A and the second information processing apparatus 130B are different from each other.

The first information processing apparatus 130A is an apparatus used when the administrator accesses the data storage section 116 for the first time by using the NFC sticker 200. The second information processing apparatus 130B is an apparatus used when the non-administrator user accesses the data storage section 116 for a second or subsequent time by using the same NFC sticker 200.

Functional structural elements of the first information processing apparatus 130A and the second information processing apparatus 130B are the same as the above-described information processing apparatus 130, and the functional structural elements of the first and second information processing apparatuses 130A and 130B will be described using the similar signs to the functional structural elements of the information processing apparatus 130.

In addition, an application ID assigned to the first information processing apparatus 130A is referred to as an application ID 1352A. An application ID assigned to the second information processing apparatus 130B is referred to as an application ID 1352B, and a member ID assigned to the second information processing apparatus 130B is referred to as a member ID 1354B.

(Operation Performed During Administrator Use)

Here, it is assumed that the boxes are already created by the administrator and the non-administrator user. The administrator executes the application program 1351 by using the first information processing apparatus 130A that has been used at the time of the first access to the NFC sticker 200.

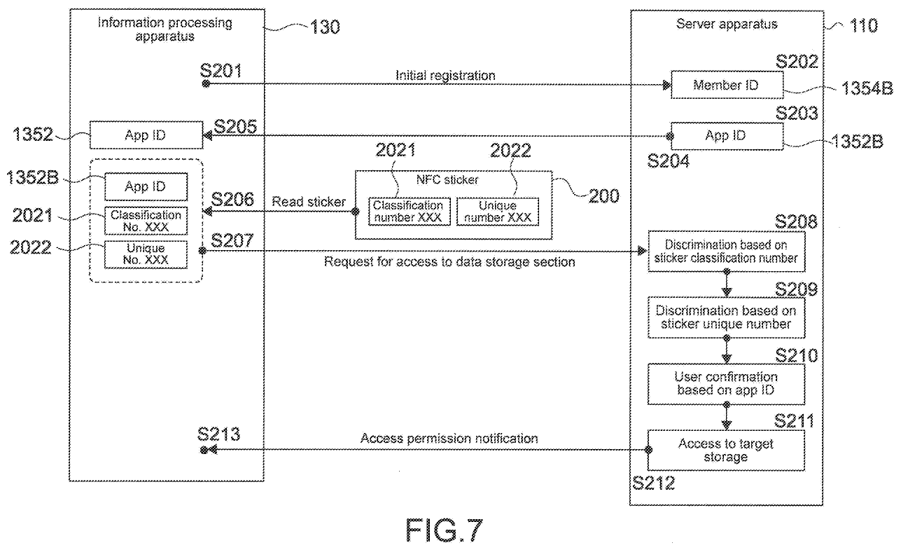

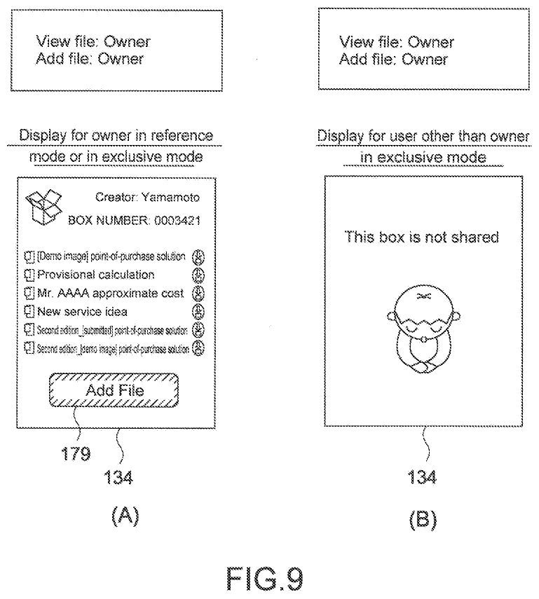

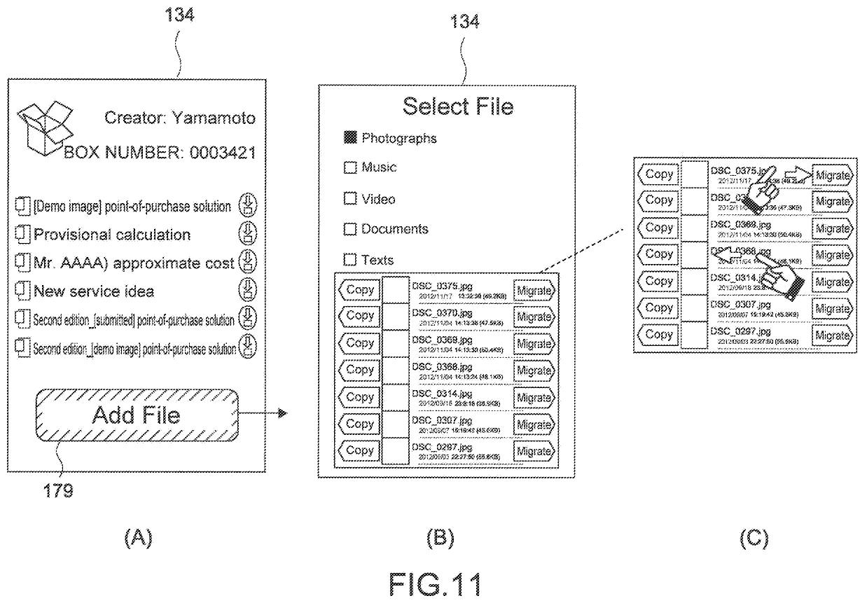

FIG. 7 is a sequence diagram illustrating operation of the information processing system. FIG. 5, FIG. 8, FIG. 9, and FIG. 11 to FIG. 13 are examples of a screen displayed on the display section 134 of the information processing apparatus 130 when executing the application program 1351.

FIG. 8(A) illustrates a display screen displayed in the case where the “View Box” button 171 is selected on the task selection screen illustrated in FIG. 5. FIG. 8(B) is a display screen displayed in the case where the box is set to the open mode.

FIG. 8(C) is a display screen displayed in the case where the owner of the box is not the administrator who is the user of the first information processing apparatus 130A, and the box is set to the reference mode.

FIG. 9(A) is a display screen displayed in the case where the owner of the box is the administrator who is the user of the first information processing apparatus 130A, and the box is set to the reference mode or the exclusive mode.

FIG. 9(B) is a display screen displayed in the case where the owner of the box is not the administrator who is the user of the first information processing apparatus 130A, and the box is set to the exclusive mode.

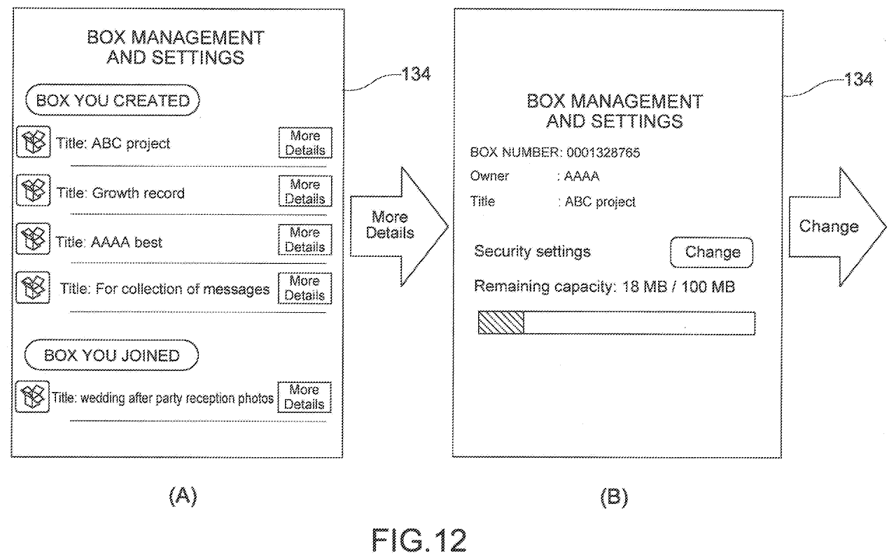

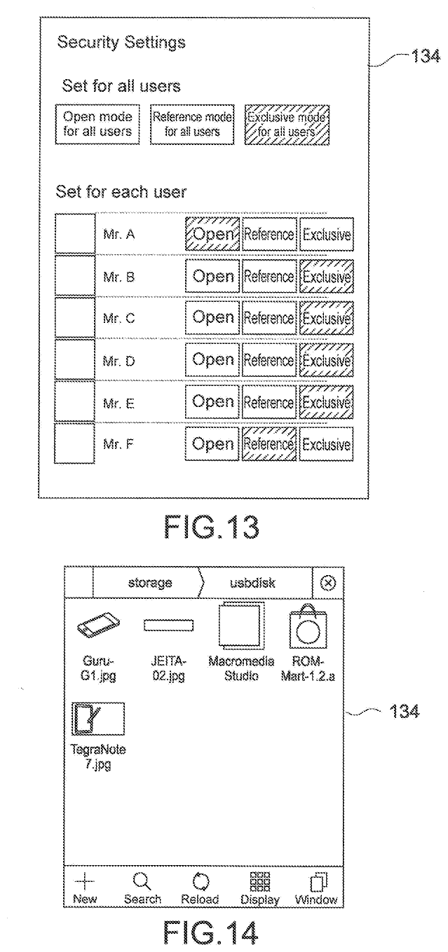

FIG. 11 illustrates display screens of a task of storing data in the data storage section 116. FIG. 12 and FIG. 13 illustrate display screens displayed in the case where the “Box Management Settings” button 172 illustrated in FIG. 5 is selected.

When the application program 1351 is executed, Steps S201 to S205 that are related to the initial registration illustrated in FIG. 7 are skipped because the application ID 1352 is already assigned to the first information processing apparatus 130A. The second control section 132 causes the display section 134 to display the selection screen for selecting from among the “Create Box” button, the “View Box” button, and the “Box Management Settings” button illustrated in FIG. 5.

The “Create Box” button 170 is selected in the case where the administrator newly creates a box different from the box that has already been created. Operation performed in the case where the task of “creating a box” is selected is similar to Step S106 to Step S118 described above. Accordingly, repeated description will be omitted here. In such a way, it is possible to create the plurality of boxes with regard to the single NFC sticker 200.

Next, when the administrator selects the “View Box” button 171 in the selection screen illustrated in FIG. 5, the second control section 132 causes the display section 134 to display the image 173 that instructs to bring the information processing apparatus 130A close to the NFC sticker 200 and connect them through the short range wireless communication as illustrated in FIG. 8(A).

When the administrator holds the information processing apparatus 130A over the NFC sticker 200 in accordance with the image 173 and the short range wireless communication is established between the information processing apparatus 130A and the NFC sticker 200, it becomes possible to read information regarding the NFC sticker 200. The second control section 132 causes the short range wireless communication section 133 to receive the classification number 2021 and the unique number 2022 that are the information regarding the NFC sticker 200 (Step S206).

The second control section 132 causes the second communication section 131 to transmit, to the server apparatus 110, the acquired classification number 201 and unique number 2022 of the NFC sticker 200 and the application ID 1352A assigned by the server apparatus 110 at the time of initial registration (Step S207).

When the classification number 2021, the unique number 2022, and the application ID 1352A are transmitted, access to the data storage section 116 of the server apparatus 110 and viewing of the box are requested.

When the first communication section 111 receives the request for the access to the data storage section 116 from the information processing apparatus 130A, the first control section 112 causes the acquisition section 115 to acquire the received classification number 2021, unique number 0222, and application ID 1352A.

The first control section 112 causes the determination section 117 to determine whether or not to permit the access to a predetermined storage area in the data storage section 116 from the first information processing apparatus 130A that has accessed the predetermined storage area.

Specifically, the classification number discrimination section 1171 of the determination section 117 discriminates whether or not the classification number 2021 is a classification number 2021 stored in the memory section 113 (Step S208). Here, information for permitting the access is stored in the memory section 113 because the administrator has already accessed the data storage section 116 by using the NFC sticker 200. Therefore, the classification number 2021 is discriminated as a classification number identical to the classification number 2021 stored in the memory section 113, and access authority is discriminated as the access authority that permits the administrator and the non-administrator user to access the data storage section 116 on the basis of the classification number 2021.

Next, the unique number discrimination section 1172 discriminates whether or not the acquired unique number 2022 is identical to a unique number 2022 stored in the memory section 113 in association with the classification number 2021 that has been discriminated as a classification number stored in the memory section 113 in Step S208 (Step S209). Here, the acquired unique number 2022 is discriminated as a unique number identical to the unique number 2022 stored in the memory section 113.

Next, the confirmation section 1173 discriminates whether or not the acquired application ID 1352A is identical to the application ID 1352 associated with the classification number 2021 and the unique number 2022 that have been discriminated as numbers stored in the memory section 113 in Step S209, and confirms whether the user is the administrator or the non-administrator user (Step S210).

When the application ID 1352A is discriminated as the application ID 1352 identical to the application ID 1352 stored in the memory section 133, the confirmation section 1173 confirms whether the user of the information processing apparatus 130A is the administrator or the non-administrator user, on the basis of information indicating the administrator or the non-administrator user associated with the classification number 2021, unique number 2022, and application ID 1352 that have been discriminated as being stored in the memory section 113. Here, the confirmation section 1173 confirms that the user is the administrator.

On the basis of the results obtained in Step S208 to Step S210, the access permission determination section 1174 determines whether to permit or prohibit the access from the first information processing apparatus 130A to the predetermined storage area in the data storage section 116. Here, the user of the first information processing apparatus 130A that has requested the access is the administrator. Therefore, the access permission determination section 1174 determines to permit the access to the predetermined storage area in the data storage section 116.

The first control section 112 permits the information processing apparatus 130A to access the data storage section 116 on the basis of a determination result obtained by the access permission determination section 1174 of the determination section 117 (Step S211).

The first control section 112 causes the first communication section 111 to transmit an access permission notification to the first information processing apparatus 130A (Step S212).

When the second communication section 131 receives the access permission notification (Step S213), the second control section 132 causes the display section 134 to display a list (not illustrated) of title names of boxes created in the predetermined storage area in the data storage section 116.

When the administrator selects a box set to the open mode from among the boxes displayed in the list, the first control section 112 causes the display section 134 to display the box number, an “Add File” button 179, and a list of names of files stored in the selected box as illustrated in FIG. 8(B).

The administrator taps and selects a displayed name of a file, and refers to the file.

In FIG. 8(B), the box is set to the open mode. Therefore, the “Add File” button 179 is usable. The administrator makes it possible to store a file in the box by tapping the button 179. In addition, it is also possible for the administrator to delete a file.

FIG. 11 is a diagram for describing display screens displayed in the case where the “Add File” button 179 is tapped. Note that, FIG. 11(A) is the same diagram as FIG. 8(B).

When the “Add File” button 179 is tapped in the display screen illustrated in FIG. 11(A), the first control section 112 causes the display section 134 to display an addition file selection screen as illustrated in FIG. 11(B). Files displayed on the selection screen are data stored in the data memory section 137.

Pieces of the data stored in the data memory section 137 are classified into photographs, music, videos, documents, texts, or the like by filename extensions attached to the end of the file names, for example. The display section 134 displays the classifications. In addition, when the administrator selects a classification, the display section 134 displays a list of files belonging in the classification.

FIG. 11(C) is a partially enlarged diagram of FIG. 11(B). The administrator selects a file to be stored in the data storage section 116 from the list of the files.

For example, in the case of storing the file in the data storage section 116 and deleting the file from the data memory section 137 of the first information processing apparatus 130A, it is only necessary to put a finger on the name of the target file and swipe the finger to the right toward the display of “Migrate” as illustrated in FIG. 11(C).

On the other hand, in the case of storing a file in the data storage section 116 while leaving the file in the data memory section 137, it is only necessary to put a finger on the name of the target file and swipe the finger to the left toward the display of “Copy” as illustrated in FIG. 11(C).

As described above, it is also possible to configure the system in a manner that a task of leaving/deleting a file to be stored in the data storage section 116 in/from the first information processing apparatus 130A can be executed concurrently with a task of storing the data in the data storage section 116. This makes it possible to improve workability.

Here, the example of selecting the box set to the open mode has been described. Accordingly, it is possible to refer to, store, and delete data regardless of whether the owner of the box is the administrator or the non-administrator user.

On the other hand, in the case of selecting a box that is set to the reference mode and that is created by an owner who is the non-administrator user other than the administrator, the administrator is not the owner of the box. Therefore, the administrator can refer to files in the box, but cannot store or delete files. In this case, as illustrated in FIG. 8(C), the display section 134 displays a screen in which the “Add File” button 179 is disabled and the administrator cannot tap the “Add File” button 179.

In addition, in the case of selecting a box that is set to the exclusive mode and that is created by an owner who is the non-administrator user other than the administrator, the administrator is not the owner of the box. Therefore, the administrator cannot refer to, store, or delete files in the box. In this case, as illustrated in FIG. 9(B), the display section 134 displays a message that says “This box is not shared”.

In addition, in the case of selecting a box that is set to the reference mode or the exclusive mode and that is created by an owner who is the administrator, the administrator is the owner of the box. Therefore, the administrator is capable of referring to, storing, and deleting files in the box.

In this case, as illustrated in FIG. 9(A), the box number, the “Add File” button 179, and a list of names of files stored in the selected box are displayed. The “Add File” button 179 is usable, and the administrator is capable of referring to, storing, and deleting files in the box by tapping the button 179.

Next, a case where the administrator changes management settings will be described. In the case of changing the management settings, the “Box Management Settings” button 172 illustrated in FIG. 5 is selected.

In the box management settings, it is possible to change a title name of a box, a name of an owner, a disclosure level, or the like. Here, the change in the disclosure level will be described. However, it is also possible to set the title name of the box, the name of the owner, and the like in a changeable manner.

When the administrator selects the “Box Management Settings” button 172 on the display screen illustrated in FIG. 5, the above-described Steps S206 to S213 are executed, and access to the data storage section and configuration of the box management settings are requested. When the access permission is received in Step S213, the second control section 132 causes the display section 134 to display a list of boxes created in the predetermined storage area as illustrated in FIG. 12(A).

The display section 134 displays a field of “Boxes You Created” and a field of “Boxes You Joined”. In the field of “Boxes You Created”, names of boxes created by an owner who is the administrator are displayed. In the field of “Boxes You Joined”, a name of a box that is created by an owner who is the non-administrator user is displayed. This box includes a file handled by the administrator such as accessing, referring to, or storing the file.

Only the owner of a box is capable of changing the box management settings. In other words, it is possible to change management settings with regard to only the boxes displayed in the field of “Boxes You Created”.

When the administrator taps a name of a box of which the administrator wants to change a management setting on the display screen illustrated in FIG. 12(A), the second control section 132 causes the display section 134 to display details of box information as illustrated in FIG. 12(B). The box information includes a box name, an owner name, a title name, security settings, remaining storage capacity, or the like.

When the administrator taps a button for changing security settings, the second control section 132 causes the display section 134 to display items related to the disclosure levels as illustrated in FIG. 13. For example, the display section 134 displays a screen for setting a disclosure level mode for all non-administrator users or disclosure level modes for the respective non-administrator users.

In FIG. 13, the wording “Open” means the open mode that permits a user to refer to, store, and delete data in the box. The wording “Reference” means the reference mode that permits a user to refer to data in the box but prohibits the user from storing or deleting data in the box. The wording “Exclusive” means the exclusive mode that prohibits a user from referring to, storing, or deleting data in the box.

The administrator is capable of changing a disclosure level mode for all non-administrator users or disclosure level modes for the respective non-administrator users.

(Operation Performed during Non-Administrator User Use)

Next, a case where the non-administrator user of the NFC sticker 200 uses the NFC sticker 200 and the second information processing apparatus 130B that is different from the first information processing apparatus 130A used by the administrator of the NFC sticker 200.

Next, the following description will be given with reference to FIG. 5, FIG. 7 to FIG. 9, and FIG. 11 to FIG. 13. FIG. 8(C) is a display screen displayed in the case where the owner of the box is not the non-administrator user who is the user of the second information processing apparatus 130B, and the box is set to the reference mode.

FIG. 9(A) is a display screen displayed in the case where the owner of the box is the non-administrator user who is the user of the second information processing apparatus 130B, and the box is set to the reference mode or the exclusive mode. FIG. 9(B) is a display screen displayed in the case where the owner of the box is not the non-administrator user who is the user of the second information processing apparatus 130B, and the box is set to the exclusive mode.

Next, the following description will be given with reference to FIG. 7.

First, the non-administrator user installs the application program 1351 into the second information processing apparatus 130B.

When the application program 1351 installed by the non-administrator user is executed for the first time, the second control section 132 causes the display section 134 to display the initial registration setting screen (not illustrated). The user finishes inputting input items such as personal information on the initial registration setting screen, and selects execution of the initial registration (Step S201).

The second control section 132 causes the second communication section 131 to transmit information regarding the solid recognition number of the information processing apparatus 130B, the personal information, a request for the initial registration, and the like to the server apparatus 110 via the communication network 120.

The first communication section 111 of the server apparatus 110 receives the request from the second information processing apparatus 130B. In response to the request, the first control section 112 causes the ID generation section 114 to generate a member ID 1354B for specifying a user specific to the second information processing apparatus 130B on the basis of the received solid recognition number and personal information (Step S202).

In addition, the first control section 112 causes the ID generation section 114 to generate the application ID 1352 on the basis of the received solid recognition number (Step S203). The application ID 1352 serves as the recognition number of the second information processing apparatus 130B. Different application IDs are assigned to different information processing apparatuses.

The first control section 112 causes the first communication section 111 to transmit the generated application ID 1352B to the second information processing apparatus 130B (Step S204). When the second information processing apparatus 130B receives the application ID 1352, the application ID 1352B is assigned to the second information processing apparatus 130B (Step S205).

In such a way, the initial registration of the second information processing apparatus 130B is completed. Note that, Steps S201 to S205 related to the initial registration are skipped in the case where the second information processing apparatus 130B has already had the application ID.

When the initial registration of the non-administrator user is completed, the second control section 132 causes the display section 134 to display the task selection screen illustrated in FIG. 5. As illustrated in FIG. 5, the display section 134 displays the three selection buttons including the “Create Box” button, the “View Box” button, and the “Box Management Settings” button.

In the case where the non-administrator user newly creates a box, a task of “creating a box” is selected. Operation performed in the case where the task of “creating a box” is selected is similar to Step S106 to Step S118 described above. Accordingly, repeated description will be omitted here.

Here, the case where the NFC sticker 200 has authority that permits access from the administrator and the non-administrator user is taken as an example. Therefore, it is also possible for the non-administrator user to create a box through steps similar to Steps S106 to S118 described above.

On the other hand, in the case of using an NFC sticker 200 having authority that only permits access from the administrator, Steps S206 to S210 described above are executed when the task of “creating a box” is selected.

In this case, the type of the access authority is discriminated on the basis of the classification number 2021 in Step S208, and it is confirmed whether the user is the administrator or the non-administrator user in Step S210. When the type of the access authority is discriminated as the authority that only permits access from the administrator in Step S208 and the user is confirmed as the non-administrator user in Step S210, the access permission determination section 1174 determines to prohibit access from the second information processing apparatus 130B to the data storage section 116.

When the access permission determination section 1174 of the determination section 117 determines to prohibit the access, the first control section 112 transmits an instruction to the second information processing apparatus 130B. The instruction causes the display section 134 to display a notification that “This NFC sticker cannot be used”.

Next, Steps S206 to S213 described above are executed when the non-administrator user selects the task of “viewing a box”.

When the second communication section 131 receives the access permission notification (Step S213), the second control section 132 causes the display section 134 to display a list (not illustrated) of boxes created in the data storage section 116.

When the non-administrator user selects a box set to the open mode, the first control section 112 causes the display section 134 to display a list of names of files stored in the selected box as illustrated in FIG. 8(B).

The non-administrator user is capable of referring to a file by tapping and selecting a displayed name of the file. In addition, in the case of viewing the box in the open mode, the “Add File” button 179 is usable as illustrated in FIG. 8(B). Therefore, the non-administrator user is capable of storing a file in the box by selecting the button 179. In addition, it is also possible for the non-administrator user to delete a file.

When the owner of the box is a user other than the non-administrator user who operates the second information processing apparatus 130B and the non-administrator user selects the box set to the reference mode, the first control section 112 causes the display section 134 of the second information processing apparatus 130B to display the list of names of files stored in the selected box as illustrated in FIG. 8(C).

In FIG. 8(C), the “Add File” button 179 is disabled, and it is impossible to store/delete files in/from the box. The non-administrator user is only capable of referring to a file by tapping and selecting a displayed name of the file.

Alternatively, when the owner of the box is a user other than the non-administrator user who operates the second information processing apparatus 130B and the non-administrator user selects a box set to the exclusive mode, the display section 134 displays a message that says “This box is not shared” as illustrated in FIG. 9(B). It is impossible for the non-administrator user to refer to, store, or delete files in the box.

Alternatively, in the case of selecting a box that is set to the reference mode or the exclusive mode and that is created by an owner who is the non-administrator user operating the second information processing apparatus 130B, the non-administrator user is the owner of the box. Therefore, the non-administrator user is capable of referring to, storing, and deleting files in the box.

In this case, as illustrated in FIG. 9(A), the box number, the “Add File” button 179, and a list of names of files stored in the selected box are displayed. The “Add File” button 179 is usable, and the administrator is capable of referring to, storing, and deleting files in the box by tapping the button 179.

Here, the case where the NFC sticker 200 has authority that permits access from the administrator and the non-administrator user has been taken as an example. However, in the case of using an NFC sticker 200 having authority that only permits access from the administrator, Steps S206 to S210 described above are executed when the task of “creating a box” is selected.

In this case, the type of the access authority is discriminated on the basis of the classification number 2021 in Step S208, and it is confirmed whether the user is the administrator or the non-administrator user in Step S210. When the type of the access authority is discriminated as the authority that only permits access from the administrator in Step S208 and the user is confirmed as the non-administrator user in Step S210, the first control section 112 transmits an instruction to the second information processing apparatus 130B. The instruction causes the display section 134 to display the notification that “This NFC sticker cannot be used”.

Next, Steps S206 to S213 described above are executed when the non-administrator user selects the task of “box management settings”.

When the second communication section 131 receives the access permission notification (Step S213), the second control section 131 causes the display section 134 to display names of boxes created in a predetermined storage area as illustrated in FIG. 12(A).

The display section 134 displays a field of “Boxes You Created” and a field of “Boxes You Joined”. In a way similar to the above-described box management settings configured by the administrator, the non-administrator user is capable of changing management settings only with regard to boxes displayed in the field of “Boxes You Created”, in other words, boxes owned by the non-administrator user who is currently operating the second information processing apparatus 130B.

On the other hand, in the case of using an NFC sticker 200 having authority that only permits access from the administrator, Steps S206 to S210 described above are executed when the task of “box management settings” is selected.

In this case, the type of the access authority is discriminated on the basis of the classification number 2021 in Step S208, and it is confirmed whether the user is the administrator or the non-administrator user in Step S210. When the type of the access authority is discriminated as the authority that only permits access from the administrator in Step S208 and the user is discriminated as the non-administrator user in Step S210, the first control section 112 transmits an instruction to the second information processing apparatus 130B. The instruction causes the display section 134 to display the notification that “This NFC sticker cannot be used”.

As described above, the short range wireless communication between the NFC sticker 200 and the information processing apparatus 130 is necessary to access the data storage section 116 of the server apparatus 110. Therefore, it is necessary for the administrator or the non-administrator user to keep the NFC sticker 200 handy. In addition, unlike QR codes, it is difficult to copy the NFC stickers. This makes it possible to physically limit the access to the data storage section. Therefore, it is possible to reduce risk of leaking data information stored in the data storage section 116.

In addition, it is possible for owners of boxes to arbitrarily set disclosure levels of the boxes (data storage spaces) created in the data storage section 116.

In addition, it is also possible for the administrator of the NFC sticker 200 to access the data storage section 116 without establishing the short range wireless communication with the actual NFC sticker 200.

In this case, it is only necessary to configure a setting in a manner that the administrator is preliminarily notified of the classification number 2021 and the unique number 2022 of the NFC sticker 200. The administrator inputs the notified classification number 2021 and unique number 2022 by using the information processing apparatus 130 that has accessed the data storage section 116 corresponding to the NFC sticker 200 for the first time by using the NFC sticker 200.

Next, the classification number 2021, the unique number 2022, and the application ID 1352 assigned to the information processing apparatus are transmitted to the server apparatus 110. This makes it possible for the information processing apparatus 130 to access the data storage section 116 without establishing the short range wireless communication with the NFC sticker 200.

[Application Examples of Information Processing System]

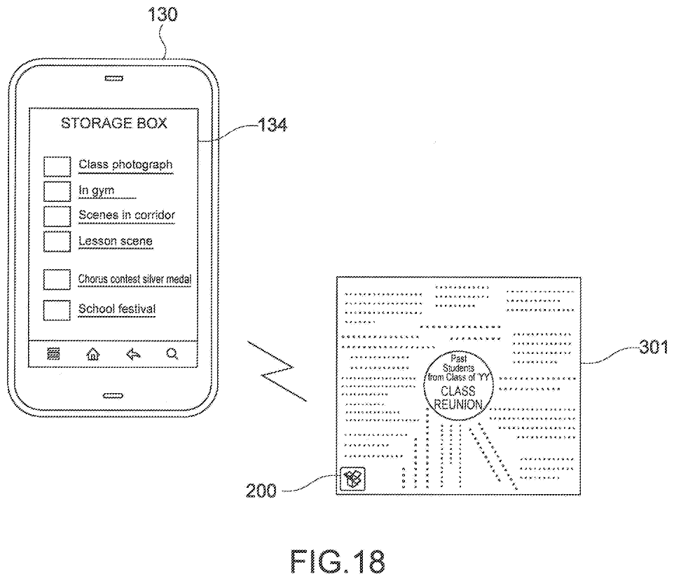

Specific application examples of the above-described information processing system will be described with reference to FIG. 18 to FIG. 21.

FIG. 18 is an application example in which the NFC sticker 200 is attached to a message card 301 with messages to an individual from school friends. The data storage section 116 of the server apparatus corresponds to the NFC sticker 200 attached to the message card 301, and stores data related to the message card 301 such as an image file including a class photograph and a video file regarding a chorus contest, for example.

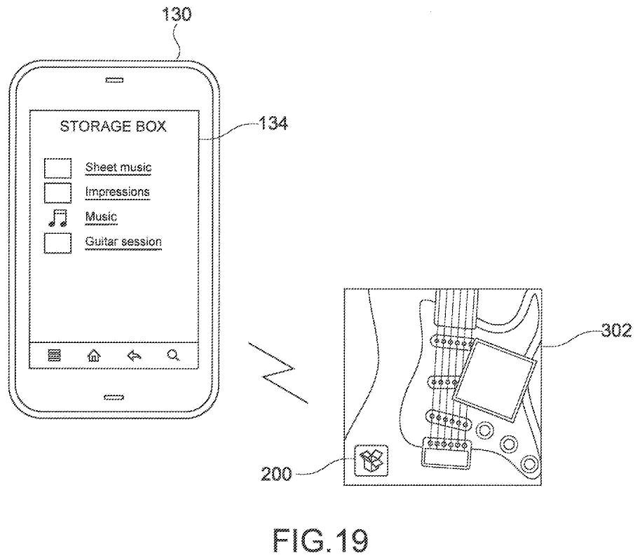

FIG. 19 is an application example in which the NFC sticker 200 is attached to a music CD 302. The data storage section 116 of the server apparatus corresponds to the NFC sticker 200 attached to the music CD 302, and stores data related to the music CD 302 such as a PDF file of sheet music, an audio file, or a document file including individual impressions, for example.

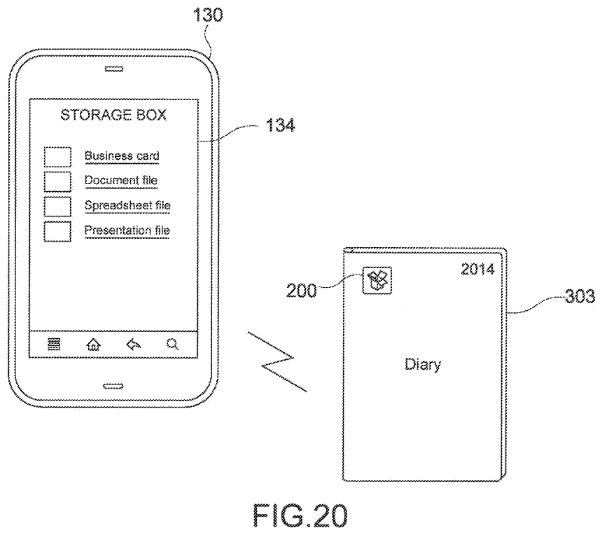

FIG. 20 is an application example in which the NFC sticker 200 is attached to a diary 303. The data storage section 116 of the server apparatus corresponds to the NFC sticker 200 attached to the diary 303, and stores data related to the diary 303 such as a PDF file of a business card, a document file related to a job, a spreadsheet file, or a presentation file, for example.

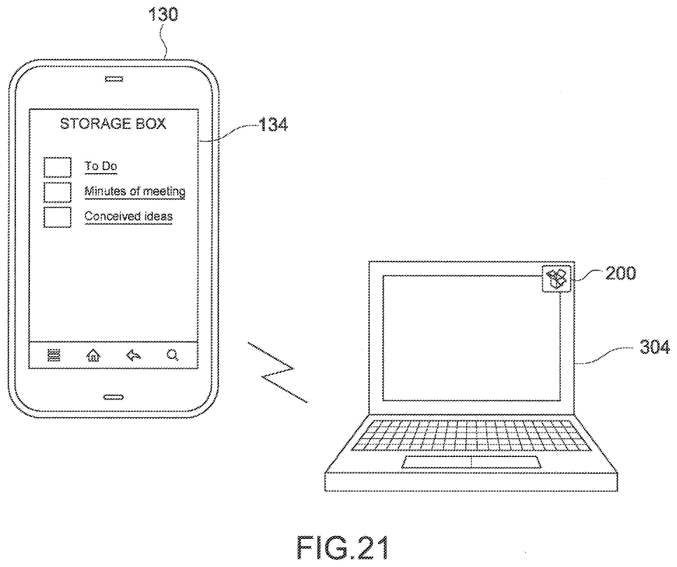

FIG. 21 is an application example in which the NFC sticker 200 is attached to a personal computer 304. The data storage section 116 of the server apparatus corresponds to the NFC sticker 200 attached to the personal computer 304, and stores data such as a file of minutes of meeting related to a job, a document file including a to-do list, or a document file including notes of conceived ideas, for example.

As described above, it is possible to store various kinds of data related to a target to which the NFC sticker 200 is attached, in a storage area in the data storage section specified by the NFC sticker 200. This makes it possible to manage information. Note that, it is possible for the user to arbitrarily decide where to attach the NFC sticker 200.

Next, the information processing apparatus 130 is held over the NFC sticker 200 and the short range wireless communication is established. This makes it possible to refer to, store, and delete various kinds of data in the storage area in the data storage section 116 corresponding to the NFC sticker 200.

Although the embodiments of the present technology have been described above, it is needless to say that the present technology is not limited only to the above-mentioned embodiments and various modifications can be made without departing from the gist of the present technology.

For example, in the above-described embodiment, the example in which the application ID is used as the identifier for identifying the information processing apparatus has been described. However, the present technology is not limited thereto. It is also possible to use a device ID (or a device identification number), for example.

The device ID (or the device identification number) is an identifier assigned by the server apparatus to each of information processing apparatuses at a time of initial registration in a manner that it is possible to discriminate the different information processing apparatuses from each other. The device IDs make it possible to discriminate whether an information processing apparatus that has requested access is the administrator or the non-administrator user in a way similar to the above-described case of using the application IDs.

In addition, instead of the identifiers for identifying different information processing apparatuses, it is also possible to use user IDs (or user recognition numbers) serving as user identifiers for identifying different users. By using the user IDs, it is possible to discriminate whether the user of the information processing apparatus that has requested access is the administrator or the non-administrator user.

The User IDs are identifiers assigned by the server apparatus to the respective users at a time of initial registration in a manner that it is possible to discriminate the different users from each other. By using the user ID, it is possible for the user to access an NFC sticker in the same role as when the user has accessed the NFC sticker for the first time, even in the case where the user uses a different information processing apparatus from the information processing apparatus used for the first access. Here, the role means a role of the administrator or a role of the non-administrator user.

In the case of using the user IDs, the access authority includes permission of access to the data storage section from only a first user of the information processing apparatus who has accessed the data storage section for a first time by using the NFC sticker (the communication device), and permission of access to the data storage section from the first user and a second user who is different from the first user and who has accessed the data storage section for a second or subsequent time by using the NFC sticker (the communication device).

In the case of using the user IDs, the confirmation section 1173 confirms whether a user of an information processing device who has requested access to the data storage section 116 is a first user of the information processing device who has accessed the data storage section 116 for the first time by using the NFC sticker (the communication device) 200, or a second user who is different from the first information processing apparatus and who has accessed the data storage section for a second or subsequent time by using the NFC sticker (the communication device). The first user is the administrator, and the second user is the non-administrator user.

In addition, the ID generation section 114 serving as the identifier generation section for generating an identifier generates a user ID in response to a request from the information processing apparatus 130. Note that, as the user IDs, it is also possible to use the member IDs according to the above-described embodiment.

In the case of using the user IDs, a user ID is generated at the time of initial registration, and is assigned to a user. Information regarding the user ID is transmitted to the server apparatus 110 when the user inputs the user ID assigned to the user into the information processing apparatus 130 at a time of access.

The first communication section 111 receives the classification number 2021, the unique number 2022, and the user ID. The first control section 112 controls access from the information processing apparatus to the data storage section 116 on the basis of the classification number 2021, the unique number 2022, and the user ID.

As described above, the user is confirmed as the administrator or the non-administrator user by using the user ID serving as the user identifier. This makes it possible to control access limitation for each user.

In addition, in the case of using the user IDs, it is possible for a user to use an NFC sticker and access the data storage section from an information processing apparatus that is different from an information processing apparatus used for the first access, while the user serves the same role as when the user has accessed the data storage section for the first time by using the NFC sticker. Note that, the first access means the time of the initial registration.

As described above, in addition to the application ID (or the application recognition number), it is also possible to use the device ID (or the device recognition number) or the like as the information processing apparatus identifier for specifying the information processing apparatus. In addition, it is also possible to use the user ID (or the user recognition number) or the like as the user identifier for specifying the user.

In addition, although FIG. 8(B) illustrates the UI design that displays a list of files in a box as an example, it is also possible to display the UI designs illustrated in FIG. 14 to FIG. 17. In addition, the above-described UI designs displayed on the display section 134 are mere examples. The present technology is not limited thereto.

Note that, the present technology may also be configured as below.

(1) An information processing apparatus including:

a communication section that communicates with a server apparatus including a data storage section;

a short range wireless communication section that establishes short range wireless communication with a communication device including an identifier for specifying an area in the data storage section or an identifier for indicating access authority over access to the data storage section and a communication device identifier for identifying its own communication device; and

a control section that causes the short range wireless communication section to acquire the area specification identifier or the identifier for indicating the access authority and the communication device identifier, causes the communication section to transmit the area specification identifier or the identifier for indicating the access authority and the communication device identifier to the server apparatus, and requests permission to access the data storage section.

(2) The information processing apparatus according to (1),

in which the control section causes the communication section to acquire an identifier for identifying the information processing apparatus or a user of the information processing apparatus, the identifier being assigned by the server apparatus, causes the short range wireless communication section to transmit the area specification identifier or the identifier for indicating the access authority, the communication device identifier, and the identifier for identifying the information processing apparatus or the user to the server apparatus, and requests permission to access the data storage section.

(3) The information processing apparatus according to (1) or (2),

in which the access authority includes permission of access to the data storage section from only a first information processing apparatus that has accessed the data storage section for a first time by using the communication device, and permission of access to the data storage section from the first information processing apparatus and a second information processing apparatus that is different from the first information processing apparatus and that has accessed the data storage section for a second or subsequent time by using the communication device.

(4) The information processing apparatus according to (1) or (2),

in which the access authority includes permission of access to the data storage section from only a first user of the information processing apparatus who has accessed the data storage section for a first time by using the communication device, and permission of access to the data storage section from the first user and a second user who is different from the first user and who has accessed the data storage section for a second or subsequent time by using the communication device.

(5) The information processing apparatus according to any one of (1) to (4),

in which an area in the data storage section accessible for the information processing device is specified on the basis of the area specification identifier or the identifier for indicting the access authority and the communication device identifier.

(6) The information processing apparatus according to any one of (1) to (5), further including a data memory section that stores data, in which the control section causes the communication section to transmit, to the server apparatus, a request to create a data storage space whose disclosure level is set to an inside of the area, and controls storing of the data in the data storage space created by the server apparatus on the basis of the request.
(7) The information processing apparatus according to (6),

in which the control section causes the communication section to transmit disclosure level information set for the data storage space to the server apparatus.

(8) The information processing apparatus according to (6) or (7), further including

a display section,

in which the control section controls display of data stored in the data storage space on the display section.

(9) The information processing apparatus according to any one of (1) to (8),

in which the short range wireless communication is NFC communication.

(10) A communication device including:

a communication antenna that establishes short range wireless communication with an information processing apparatus; and

an IC chip that includes an identifier for specifying an area in a data storage section of a server apparatus, which is used for specifying an area in the data storage section accessible for the information processing apparatus, or an identifier for indicating access authority over access to the data storage section and a communication device identifier for identifying its own communication device.

(11) The communication device according to (10), further including

a label sticker that has an adhesive layer on one surface,

in which the communication antenna and the IC chip are buried in the label sticker.

(12) The communication device according to (11),

in which another surface of the label sticker has an illustration corresponding to the identifier for indicating the access authority over access to the data storage section.

(13) The communication device according to (11) or (12),

in which another surface of the label sticker has an illustration related to content of data stored in the data storage section.

(14) A server apparatus including:

a data storage section that stores data;

a reception section that receives an area specification identifier or an identifier for indicating access authority and a communication device identifier, via an information processing apparatus that establishes short range wireless communication with a communication device including the identifier for specifying an area in a data storage section or the identifier for indicating the access authority over access to the data storage section and the communication device identifier for identifying its own communication device; and

a control section that receives a request for permission to access the data storage section from the information processing apparatus, and controls access from the information processing apparatus to the data storage section on the basis of the area specification identifier or the identifier for indicating the access authority and the communication device identifier.

(15) The server apparatus according to (14), further including

an identifier generation section that generates an identifier for identifying the information processing apparatus or a user of the information processing apparatus to be assigned to the information processing apparatus or the user, in response to a request from the information processing apparatus,

in which the reception section receives the information processing apparatus identifier from the information processing apparatus to which the identifier for identifying the information processing apparatus is assigned, or the user identifier input by the user to whom the identifier for identifying the user is assigned, and

the control section controls access from the information processing apparatus to the data storage section on the basis of the area specification identifier or the identifier for indicating the access authority, the communication device identifier, and the information processing apparatus identifier or the user identifier.

(16) The server apparatus according to (14) or (15),

in which an area in the data storage section accessible for the information processing apparatus is specified on the basis of the area specification identifier or the identifier for indicating the access authority and the communication device identifier.

(17) The server apparatus according to any one of (14) to (16), further including

a confirmation section that confirms whether the information processing apparatus that has requested access to the data storage section is a first information processing apparatus that has accessed the data storage section for a first time by using the communication device, or a second information processing apparatus that is other than the first information processing apparatus and that has accessed the data storage section for a second or subsequent time by using the communication device.

(18) The server apparatus according to any one of (14) to (16), further including

a confirmation section that confirms whether a user of the information processing device who has requested access to the data storage section is a first user of the information processing device who has accessed the data storage section for a first time by using the communication device, or a second user who is different from the first user and who has accessed the data storage section for a second or subsequent time by using the communication device.

(19) An information processing method including:

acquiring an area specification identifier or an identifier for indicating access authority and a communication device identifier through short range wireless communication from a communication device including the identifier for specifying an area in a data storage section of a server apparatus or the identifier for indicating the access authority over access to the data storage section and the communication device identifier for identifying its own communication device;

transmitting the area specification identifier or the identifier for indicating the access authority and the communication device identifier to the server apparatus; and

requesting access to the data storage section.

(20) An information processing method including:

acquiring, from an information processing apparatus, an area specification identifier or an identifier for indicating access authority and a communication device identifier that have been acquired by the information processing apparatus through short range wireless communication with a communication device including the identifier for specifying an area in a data storage section of a server apparatus or the identifier for indicating the access authority over access to the data storage section and the communication device identifier for identifying its own communication device; and

determining whether or not to permit the information processing apparatus to access the data storage section on the basis of the area specification identifier or the identifier for indicating the access authority and the communication device identifier.

### REFERENCE SIGNS LIST

110 server apparatus
111 first communication section (reception section)
112 first control section (control section)
114 ID generation section (identifier generation section)
116 data storage section
117 determination section
130 information processing apparatus
131 second communication section (communication section)
132 second control section (control section)
133 short range wireless communication section
134 display section
137 data memory section
200 NFC sticker (communication device)
201 communication antenna
202 IC chip
203 label sticker
203a another surface
1173 confirmation section
1352 application ID (information processing apparatus identifier)
2021 classification number (area specification identifier and identifier for indicating access authority)
2022 unique number (communication device identifier)

1. An information processing apparatus, comprising:
a communication section that communicates with a server apparatus including a data storage section;
a short range wireless communication section that establishes short range wireless communication with a communication device including an identifier for specifying an area in the data storage section or an identifier for indicating access authority over access to the data storage section and a communication device identifier for identifying its own communication device; and
a control section that causes the short range wireless communication section to acquire the area specification identifier or the identifier for indicating the access authority and the communication device identifier, causes the communication section to transmit the area specification identifier or the identifier for indicating the access authority and the communication device identifier to the server apparatus, and requests permission to access the data storage section.

2. The information processing apparatus according to claim 1,
wherein the control section causes the communication section to acquire an identifier for identifying the information processing apparatus or a user of the information processing apparatus, the identifier being assigned by the server apparatus, causes the short range wireless communication section to transmit the area specification identifier or the identifier for indicating the access authority, the communication device identifier, and the identifier for identifying the information processing apparatus or the user to the server apparatus, and requests permission to access the data storage section.

3. The information processing apparatus according to claim 2,
wherein the access authority includes permission of access to the data storage section from only a first information processing apparatus that has accessed the data storage section for a first time by using the communication device, and permission of access to the data storage section from the first information processing apparatus and a second information processing apparatus that is different from the first information processing apparatus and that has accessed the data storage section for a second or subsequent time by using the communication device.

4. The information processing apparatus according to claim 2,
wherein the access authority includes permission of access to the data storage section from only a first user of the information processing apparatus who has accessed the data storage section for a first time by using the communication device, and permission of access to the data storage section from the first user and a second user who is different from the first user and who has accessed the data storage section for a second or subsequent time by using the communication device.

5. The information processing apparatus according to claim 4,
wherein an area in the data storage section accessible for the information processing device is specified on a basis of the area specification identifier or the identifier for indicting the access authority and the communication device identifier.

6. The information processing apparatus according to claim 5, further comprising:
a data memory section that stores data,
wherein the control section causes the communication section to transmit, to the server apparatus, a request to create a data storage space whose disclosure level is set to an inside of the area, and controls storing of the data in the data storage space created by the server apparatus on a basis of the request.

7. The information processing apparatus according to claim 6,
wherein the control section causes the communication section to transmit disclosure level information set for the data storage space to the server apparatus.

8. The information processing apparatus according to claim 7, further comprising:
a display section,
wherein the control section controls display of data stored in the data storage space on the display section.

9. The information processing apparatus according to claim 8,
wherein the short range wireless communication is NFC communication.

10. A communication device, comprising:
a communication antenna that establishes short range wireless communication with an information processing apparatus; and
an IC chip that includes an identifier for specifying an area in a data storage section of a server apparatus, which is used for specifying an area in the data storage section accessible for the information processing apparatus, or an identifier for indicating access authority over access to the data storage section and a communication device identifier for identifying its own communication device.

11. The communication device according to claim 10, further comprising:
a label sticker that has an adhesive layer on one surface,
wherein the communication antenna and the IC chip are buried in the label sticker.

12. The communication device according to claim 11,
wherein another surface of the label sticker has an illustration corresponding to the identifier for indicating the access authority over access to the data storage section.

13. The communication device according to claim 11,
wherein another surface of the label sticker has an illustration related to content of data stored in the data storage section.

14. A server apparatus, comprising:
a data storage section that stores data;
a reception section that receives an area specification identifier or an identifier for indicating access authority and a communication device identifier, via an information processing apparatus that establishes short range wireless communication with a communication device including the identifier for specifying an area in a data storage section or the identifier for indicating the access authority over access to the data storage section and the communication device identifier for identifying its own communication device; and
a control section that receives a request for permission to access the data storage section from the information processing apparatus, and controls access from the information processing apparatus to the data storage section on a basis of the area specification identifier or the identifier for indicating the access authority and the communication device identifier.

15. The server apparatus according to claim 14, further comprising:
an identifier generation section that generates an identifier for identifying the information processing apparatus or a user of the information processing apparatus to be assigned to the information processing apparatus or the user, in response to a request from the information processing apparatus,
wherein the reception section receives the information processing apparatus identifier from the information processing apparatus to which the identifier for identifying the information processing apparatus is assigned, or the user identifier input by the user to whom the identifier for identifying the user is assigned, and
the control section controls access from the information processing apparatus to the data storage section on a basis of the area specification identifier or the identifier for indicating the access authority, the communication device identifier, and the information processing apparatus identifier or the user identifier.

16. The server apparatus according to claim 15,
wherein an area in the data storage section accessible for the information processing apparatus is specified on a basis of the area specification identifier or the identifier for indicating the access authority and the communication device identifier.

17. The server apparatus according to claim 16, further comprising:
a confirmation section that confirms whether the information processing apparatus that has requested access to the data storage section is a first information processing apparatus that has accessed the data storage section for a first time by using the communication device, or a second information processing apparatus that is other than the first information processing apparatus and that has accessed the data storage section for a second or subsequent time by using the communication device.

18. The server apparatus according to claim 16, further comprising:
a confirmation section that confirms whether a user of the information processing device who has requested access to the data storage section is a first user of the information processing device who has accessed the data storage section for a first time by using the communication device, or a second user who is different from the first user and who has accessed the data storage section for a second or subsequent time by using the communication device.

19. An information processing method, comprising:
acquiring an area specification identifier or an identifier for indicating access authority and a communication device identifier through short range wireless communication from a communication device including the identifier for specifying an area in a data storage section of a server apparatus or the identifier for indicating the access authority over access to the data storage section and the communication device identifier for identifying its own communication device;
transmitting the area specification identifier or the identifier for indicating the access authority and the communication device identifier to the server apparatus; and
requesting access to the data storage section.

20. An information processing method, comprising:
acquiring, from an information processing apparatus, an area specification identifier or an identifier for indicating access authority and a communication device identifier that have been acquired by the information processing apparatus through short range wireless communication with a communication device including the identifier for specifying an area in a data storage section of a server apparatus or the identifier for indicating the access authority over access to the data storage section and the communication device identifier for identifying its own communication device; and
determining whether or not to permit the information processing apparatus to access the data storage section on a basis of the area specification identifier or the identifier for indicating the access authority and the communication device identifier.
